(19) United States
(12) Patent Application Publication
(10) Pub. No.: US 2026/0262026 A1
(43) Pub. Date: Sep. 3, 2026

(54) TERMINAL, BASE STATION, AND COMMUNICATION METHOD

(71) Applicant: Panasonic Intellectual Property Corporation of America, Torrance, CA (US)

(72) Inventors: Shotaro MAKI, Tokyo (JP); Tetsuya YAMAMOTO, Kanagawa (JP); Ayako HORIUCHI, Kanagawa (JP); Hidetoshi SUZUKI, Kanagawa (JP); Jian Rong CHONG, Singapore (SG); Yoshihiko OGAWA, Kanagawa (JP)

(73) Assignee: Panasonic Intellectual Property Corporation of America, Torrance, CA (US)

(21) Appl. No.: 19/489,213

(22) PCT Filed: Jun. 5, 2024
(86) PCT No.: PCT/JP2024/020456

§ 371 Date: Dec. 1, 2025

(30) Foreign Application Priority Data
Jun. 29, 2023 (JP) 2023-107284

(51) Int. Cl. H04W 72/0457; H04W 72/0453; H04W 72/231

(52) U.S. Cl. CPC H04W 72/0457; H04W 72/0453; H04W 72/231

(57) ABSTRACT

This terminal comprises: a control circuit that determines, as reception resources for a downlink signal, resource blocks distributed and arranged on a frequency axis from among a plurality of resource blocks obtained by dividing a frequency band, the number of resource blocks included in the reception resources being equal to or less than a prescribed value; and a reception circuit that receives the downlink signal by using the reception resources.

### TECHNICAL FIELD

The present disclosure relates to a terminal, a base station, and a communication method.

### BACKGROUND ART

A communication system called the 5th generation mobile communication system (5G) has been studied. The 3rd Generation Partnership Project (3GPP), which is an international standards-developing organization, has been studying development of the 5G communication system in terms of both the development of LTE/LTE-Advanced systems and a New Radio Access Technology (also referred to as New RAT or NR), which is a new method not necessarily backward compatible with the LTE/LTE-Advanced systems (see, e.g., Non Patent Literature (hereinafter referred to as “NPL”) 1).

### CITATION LIST

### Non-Patent Literature

### NPL 1

RP-181726, “Revised WID on New Radio Access Technology”, NTT DOCOMO, September 2018

### NPL 2

RP-213661, “New SID on Study on further NR RedCap UE complexity reduction”, Ericsson, December 2021

### SUMMARY OF INVENTION

There is room for discussion on a method of allocating a downlink resource.

One non-limiting exemplary embodiment of the present disclosure facilitates providing a terminal, a base station, and a communication method that can appropriately allocate a downlink resource.

A terminal according to one exemplary embodiment of the present disclosure includes: control circuitry, which, in operation, determines, as a reception resource for a downlink signal, resource blocks distributedly mapped on a frequency axis among a plurality of resource blocks obtained by dividing a frequency band, wherein, a number of the resource blocks included in the reception resource is equal to or less than a defined value; and reception circuitry, which, in operation, receives the downlink signal by using the reception resource.

Note that general or specific embodiments may be implemented as a system, an apparatus, a method, an integrated circuit, a computer program, a storage medium, or any selective combination thereof.

According to one embodiment of the present disclosure, a downlink resource can be appropriately allocated.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a block diagram illustrating an exemplary configuration of a part of a base station;

FIG. 2 is a block diagram illustrating an exemplary configuration of a part of a terminal;

FIG. 3 is a block diagram illustrating an exemplary configuration of the base station;

FIG. 4 is a block diagram illustrating an exemplary configuration of the terminal;

FIG. 5 is a diagram illustrating an exemplary operation of the base station and the terminal;

FIG. 6 is a diagram illustrating an example of resource allocation;

FIG. 7 is a diagram illustrating another example of the resource allocation;

FIG. 8 is a diagram illustrating still another example of the resource allocation;

FIG. 9 is a diagram illustrating an operation example of a base station and a terminal;

FIG. 10 is a diagram illustrating an example of resource allocation;

FIG. 11 is a diagram illustrating another example of the resource allocation;

FIG. 12 is a diagram illustrating still another example of the resource allocation;

FIG. 13 is a diagram illustrating a configuration example of a Resource Block Group (RBG);

FIG. 14 is a diagram illustrating a configuration example of RBGs;

FIG. 15 is a diagram illustrating an example of resource allocation;

FIG. 16 is a diagram illustrating another example of the resource allocation;

FIG. 17 is a diagram illustrating still another example of the resource allocation;

FIG. 18 illustrates an exemplary architecture for a 3GPP NR system;

FIG. 19 illustrates functional split between NG-RAN and 5GC;

FIG. 20 is a sequence diagram of a Radio Resource Control (RRC) connection setup/reconfiguration procedure;

FIG. 21 is a schematic diagram illustrating usage scenarios of enhanced Mobile BroadBand (eMBB), massive Machine Type Communications (mMTC), and Ultra Reliable and Low Latency Communications (URLLC); and

FIG. 22 is a block diagram illustrating an exemplary 5G system architecture for a non-roaming scenario.

### DESCRIPTION OF EMBODIMENTS

Hereinafter, embodiments of the present disclosure will be described in detail with reference to the accompanying drawings.

Note that, in the following description, a radio frame, a slot, and a symbol are, for example, each a physical resource unit in a time domain, for example. For example, the length of one frame may be 10 milliseconds. For example, one frame may be configured by a plurality (e.g., 10, 20, or another value) of slots. Further, for example, the number of slots configuring one frame may be variable depending on the slot length. Furthermore, for example, one slot may be configured by a plurality (e.g., 14 or 12) of symbols. For example, one symbol is the smallest physical resource unit in the time domain, and the symbol length may vary depending on the subcarrier spacing (SCS).

Further, a subcarrier and a resource block (RB) are each a physical resource unit in a frequency domain. For example, one resource block may be configured by 12 subcarriers. For example, one subcarrier may be the smallest physical resource unit in the frequency domain. The subcarrier spacing is variable, and may be 15 kHz, 30 kHz, 60 kHz, 120 kHz, 240 kHz, 480 kHz, and 960 kHz or another value, for example.

### Regarding evolved Reduced Capability NR Devices

In Release 18 NR (hereinafter, also referred to as Rel-18), it is expected that specifications for implementing a terminal (e.g., mobile station or user equipment (UE)) called evolved Reduced Capability NR Devices (eRedCap) (e.g., referred to as an eRedCap terminal) will be defined (e.g., see NPL 2). The eRedCap terminal aims to reduce, for example, power consumption or cost by restricting a part of supporting features or performance (e.g., capability) as compared with Release 15/16/17 (also referred to as Rel-15/16/17) or the like and to realize support for various use cases.

The processing capability of the eRedCap terminal may be restricted to reduce cost. For example, an upper limit value of the number of resource blocks (RBs) of a downlink data channel (e.g., physical downlink shared channel (PDSCH)) that can be processed by the eRedCap terminal per slot may be as follows.
25 for 15 kHz SCS
12 for 30 kHz SCS

Further, an upper limit value of a bandwidth of Bandwidth part (BWP) configured for the eRedCap terminal may be about 20 MHz. The upper limit value (20 MHz) of the bandwidth of BWP is as follows, after conversion to the number of RBs.
106 for 15 kHz SCS
51 for 30 kHz SCS

A method of allocating a downlink resource (e.g., PDSCH resource) to the eRedCap terminal having such limited processing capability has not been sufficiently discussed.

Therefore, in one non-limiting exemplary embodiment of the present disclosure, a method of appropriately allocating a PDSCH resource to the eRedCap terminal will be described.

For example, a method of using a resource block group (RBG) is exemplified as a method of allocating a PDSCH resource to the terminal. In this method, for example, a plurality of RBs (a group of RBs) included in the BWP is divided (grouped) into a plurality of RBGs. Then, to which RBG the PDSCH resource is allocated by a control signal is indicated to the terminal. The indication of the RBG to be allocated by the control signal may be represented by, for example, a bitmap, and one bit may correspond to each of the RBGs. For example, the PDSCH resource may be allocated to the RBG for which the corresponding bit is 1, and the PDSCH resource may not be allocated to the RBG for which the corresponding bit is 0.

In the method of using an RBG, since the PDSCH resource can be allocated to the RBs distributed (dispersed) on the frequency axis, the reception performance is improved by frequency diversity gain.

Meanwhile, in the method of using an RBG, in a case where a size (e.g., the number of RBs included in the RBG) of the configured RBG is small and the number of RBGs is large, the number of bits in the bitmap used for the indication of the RBGs increases, so that the overhead of the control signal possibly increases.

Further, in the method of using RBGs, in a case where the size (e.g., the number of RBs included in the RBG) of the configured RBG is large, the flexibility of the number of allocated RBs possibly decreases. For example, for 15 kHz SCS, a BWP including 106 RBs corresponding to 20 MHz may be configured. In this case, in a case where the RBG size is 16, the upper limit value of the processing capability of the eRedCap terminal, which is 25 RBs, cannot be indicated to the eRedCap terminal by the control signal in some cases. This is because 25 is not a multiple of 16.

Further, for example, a method of using a resource indication value (RIV) is exemplified as another method of allocating a PDSCH resource to the terminal. The RIV is a value obtained by encoding an initial (e.g., top or first) RB position (e.g., RB index) and the number of RBs of a group of consecutive RBs to which the PDSCH resource is allocated. The terminal can specify the group of consecutive RBs to which the PDSCH resource is allocated, by decoding the received RIV.

In the method of using the RIV, the number of RBs can be flexibly allocated. Meanwhlie, in the method of using the RIV, a group of consecutive RBs is allocatable, but a group of non-consecutive RBs is not allocatable, so that the frequency diversity gain is small, and the reception performance possibly deteriorates.

Hereinafter, for example, a method of improving the reception performance by the frequency diversity gain and improving the flexibility of PDSCH resource allocation (e.g., allocation of the number of RBs) will be described.

For example, the eRedCap terminal specifies resource blocks (RBs) distributed on the frequency axis as a resource used for receiving PDSCH. In this case, the specified number of RBs is equal to or less than a threshold value (e.g., the upper limit value of the number of RBs based on the processing capability of the eRedCap terminal). As a result, the eRedCap terminal can receive PDSCH by the number of RBs suitable for the eRedCap terminal, and the received quality is thus improved by the frequency diversity gain with the RBs distributed on the frequency axis.

### Overview of Communication System

A communication system according to the present embodiment includes base station 100 and terminal 200. Terminal 200 is, for example, an eRedCap terminal.

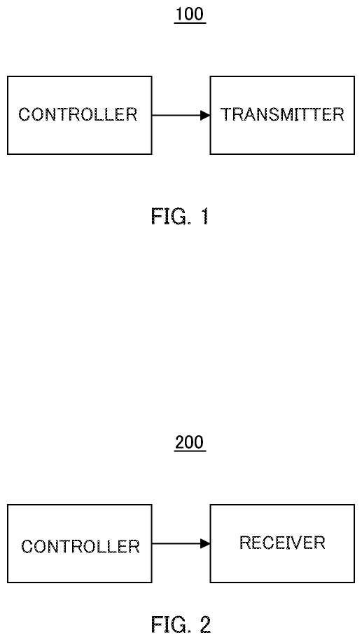

FIG. 1 is a block diagram illustrating a partial configuration example of base station 100 according to the present embodiment. In base station 100 illustrated in FIG. 1, a controller (e.g., corresponding to control circuitry) determines a resource block that is distributedly mapped on a frequency axis among a plurality of resource blocks obtained by dividing a frequency band as a transmission resource of a downlink signal (e.g., PDSCH). The number of resource blocks included in the transmission resource is equal to or less than a defined value. A transmitter (e.g., corresponding to transmission circuitry) transmits the downlink signal by using the transmission resource.

FIG. 2 is a block diagram illustrating a partial configuration example of terminal 200 according to the present embodiment. In terminal 200 illustrated in FIG. 2, a controller (e.g., corresponding to control circuitry) determines a resource block that is distributedly mapped on a frequency axis among a plurality of resource blocks obtained by dividing a frequency band as a reception resource for a downlink signal (e.g., PDSCH). The number of resource blocks included in the reception resource is equal to or less than a defined value. A receiver (e.g., corresponding to reception circuitry) receives the downlink signal by using the reception resource.

### Embodiment 1

For example, in a case where the total number of RBs included in the RBG indicated from base station 100 is larger than a threshold value, terminal 200 specifies a part (one or some) of the group of RBs of the indicated RBG as a resource used for receiving PDSCH. In this case, the total number of RBs included in the specified part of the group of RBs is equal to or less than the threshold value. As a result, terminal 200 can receive PDSCH by the number of RBs suitable for terminal 200. Further, the received quality is improved by frequency diversity gain with the RBs distributed on the frequency axis.

### Configuration of Base Station

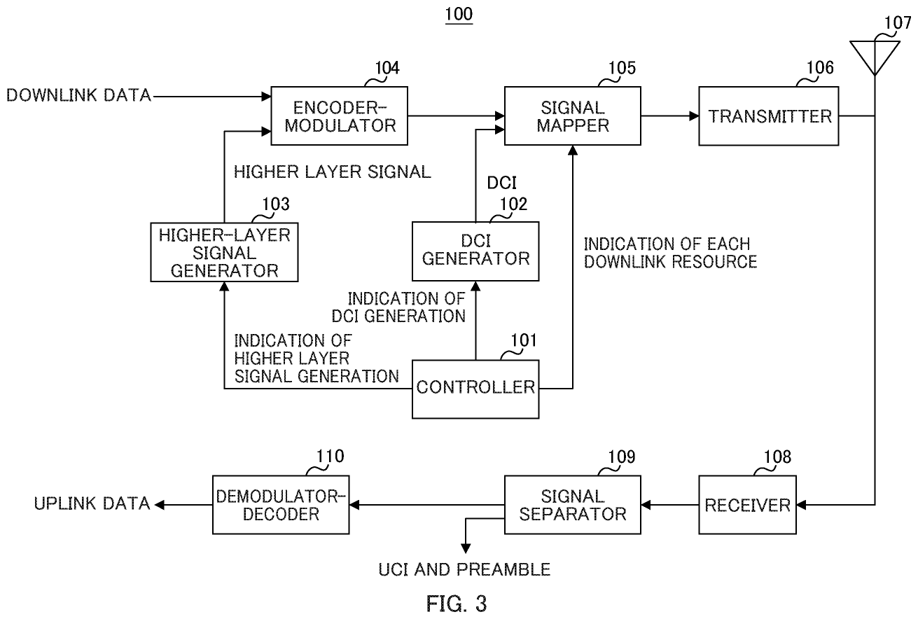

FIG. 3 is a block diagram illustrating an exemplary configuration of base station 100 according to the present embodiment. In FIG. 3, base station 100 includes controller 101, downlink control information (DCI) generator 102, higher-layer signal generator 103, encoder-modulator 104, signal mapper 105, transmitter 106, antenna 107, receiver 108, signal separator 109, and demodulator-decoder 110.

For example, at least one of controller 101, DCI generator 102, higher-layer signal generator 103, encoder-modulator 104, signal mapper 105, signal separator 109, and demodulator-decoder 110 illustrated in FIG. 3 may be included in the controller illustrated in FIG. 1. For example, at least one of transmitter 106 and antenna 107 illustrated in FIG. 3 may be included in the receiver illustrated in FIG. 1.

Controller 101 may determine, for example, information on configuration of PDSCH or resource allocation. Further, controller 101 may indicate higher-layer signal generator 103 to generate a higher layer signal (also referred to as a higher layer parameter or higher layer signaling) based on the determined information. Further, controller 101 may indicate DCI generator 102 to generate control information (e.g., DCI) included in a downlink control channel (e.g., physical downlink control channel (PDCCH)) based on the determined information.

Further, controller 101 outputs (or indicates) information on a downlink resource (e.g., PDSCH resource or PDCCH resource) to signal mapper 105.

DCI generator 102 may generate the DCI based on, for example, the indication from controller 101, and output the generated DCI to signal mapper 105.

Higher-layer signal generator 103 may generate a higher layer signal, such as system information based on, for example, the indication from controller 101, and output the generated higher layer signal to encoder-modulator 104.

Encoder-modulator 104 may perform error correction coding and modulation on, for example, the downlink data and the higher layer signal input from higher-layer signal generator 103 and output the modulated signal to signal mapper 105.

Signal mapper 105 may map the DCI input from DCI generator 102 to a downlink control channel (e.g., PDCCH) and map the signal input from encoder-modulator 104 to PDSCH based on, for example, information on the downlink resource (e.g., the PDSCH resource) input from controller 101. Signal mapper 105 outputs the signal mapped to each resource to transmitter 106.

Transmitter 106 performs radio transmission processing including frequency conversion (e.g., up-conversion) using a carrier wave on, for example, the signal input from signal mapper 105 and outputs the signal after the radio transmission processing to antenna 107.

Antenna 107 radiates, for example, a signal (e.g., downlink signal) input from transmitter 106 toward terminal 200. Further, antenna 107 receives, for example, an uplink signal transmitted from terminal 200 and outputs the received signal to receiver 108.

The uplink signal may be, for example, a signal of a channel, such as an uplink data channel (e.g., physical uplink shared channel (PUSCH)), an uplink control channel (e.g., physical uplink control channel (PUCCH)), or a random-access channel (e.g., physical random-access channel (PRACH)).

Receiver 108 performs radio reception processing including frequency conversion (e.g., down-conversion) on, for example, the signal input from antenna 107 and outputs the signal after the radio reception processing to signal separator 109.

Signal separator 109 extracts (or separates), for example, a signal on a PUCCH resource (e.g., uplink control information (UCI)) and a signal on PRACH (e.g., preamble) from the signal input from receiver 108. Further, signal separator 109 outputs, for example, a signal on a PUSCH resource from the signal input from receiver 108 to demodulator-decoder 110.

Demodulator-decoder 110 demodulates and decodes, for example, the signal input from signal separator 109 to output the uplink data.

### Configuration of Terminal

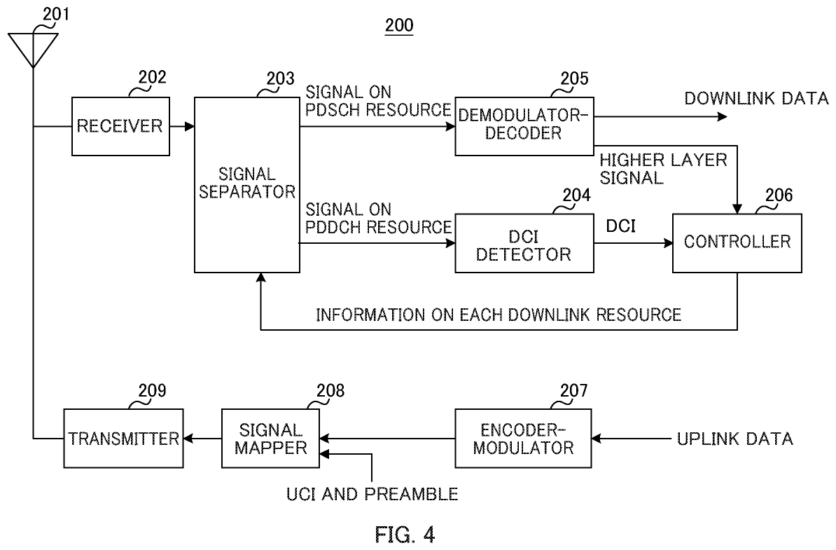

FIG. 4 is a block diagram illustrating an exemplary configuration of terminal 200 according to the present embodiment.

In FIG. 4, terminal 200 includes antenna 201, receiver 202, signal separator 203, DCI detector 204, demodulator/decoder 205, controller 206, encoder/modulator 207, signal mapper 208, and transmitter 209.

For example, at least one of signal separator 203, DCI detector 204, demodulator-decoder 205, controller 206, encoder-modulator 207, and signal mapper 208 illustrated in FIG. 4 may be included in the controller illustrated in FIG. 2. For example, at least one of antenna 201 and receiver 202 illustrated in FIG. 4 may be included in the receiver illustrated in FIG. 2.

Antenna 201 receives a downlink signal (downlink channel) transmitted by base station 100, and outputs the downlink signal to receiver 202. Further, antenna 201 radiates an uplink signal (uplink channel) input from transmitter 209 to base station 100.

For example, receiver 202 performs radio reception processing including frequency conversion (e.g., down-conversion) on the signal input from antenna 201, and outputs the signal after the radio reception processing to signal separator 203.

Signal separator 203 extracts (e.g., separates) a signal on a PDCCH resource from the signals input from receiver 202 based on the information on the downlink channel input from controller 206, for example, and outputs the signal to DCI detector 204. Further, signal separator 203 outputs, from signals input from receiver 202, a signal on a PDSCH resource to demodulator/decoder 205, based on the indication from controller 206.

For example, DCI detector 204 may detect DCI from the signal (e.g., signal on PDCCH resource) input from signal separator 203. DCI detector 204 may output the detected DCI to controller 206, for example.

For example, demodulator/decoder 205 performs demodulation and error correction decoding on the signal (e.g., signal on the PDSCH resource) input from signal separator 203, and obtain at least one of downlink data, and a higher layer signal, such as system information. For example, demodulator/decoder 205 may output the higher layer signal obtained by decoding to controller 206. Further, demodulator/decoder 205 may output the downlink data obtained by decoding, for example.

Controller 206 may determine (or specify) the downlink resource (e.g., PDSCH resource or PDCCH resource) based on, for example, at least one of the DCI input from DCI detector 204 and the higher layer signal (e.g., system information) input from demodulator-decoder 205. For example, controller 206 outputs (e.g., indicates) to signal separator 203 information on the specified downlink resource.

Encoder/modulator 207 may, for example, encode and modulate uplink data and output the modulated signal to signal mapper 208.

Signal mapper 208 may, for example, based on information on the uplink resource input from controller 206, map the signal input from encoder/modulator 207 to a PUSCH resource, map UCI to a PUCCH resource, and map a preamble to a PRACH resource. Signal mapper 208 outputs the signal mapped to each resource to transmitter 209.

Transmitter 209 performs radio transmission processing including frequency conversion (e.g., up-conversion) on the signal input from signal mapper 208, and outputs the signal after the radio transmission processing to antenna 201, for example.

### Exemplary Operation of Base Station 100 and Terminal 200

Next, an exemplary operation of base station 100 and terminal 200 described above will be described.

### Operation Example 1-1

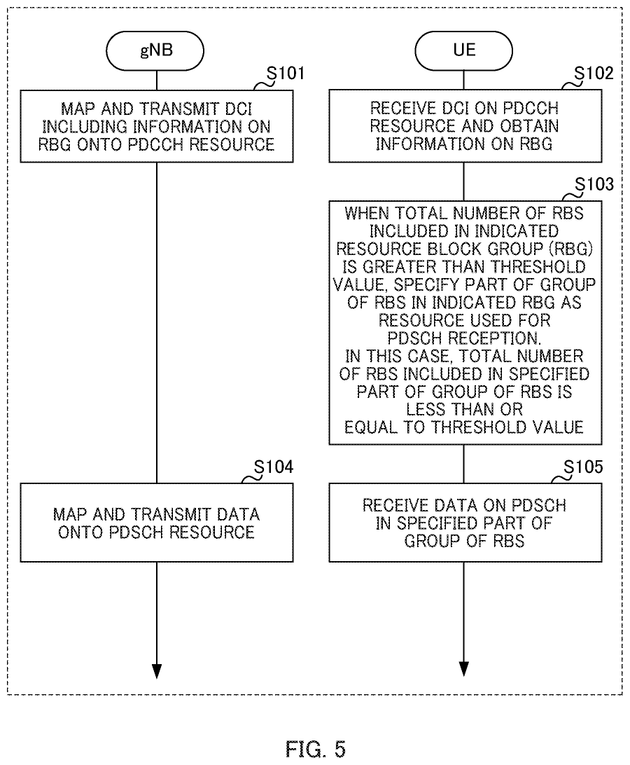

FIG. 5 is a flowchart illustrating exemplary processing of base station 100 (e.g., gNB) and terminal 200 (e.g., UE).

### S101

Base station 100, for example, maps and transmits a DCI including information on an RBG onto the PDCCH resource.

### S102

Terminal 200 receives, for example, the DCI on the PDCCH resource to obtain the information on the RBG.

### S103

In a case where the total number of RBs included in the RBG (e.g., a plurality of RBGs configured for terminal 200) indicated in S102 is larger than a threshold value (e.g., in a case of exceeding the threshold value), terminal 200 determines (or configures, specifies) a part of the group of RBs of the indicated RBG as a PDSCH reception resource. For example, a value based on the processing capability of terminal 200 (e.g., eRedCap terminal) may be configured as the threshold value. For example, the threshold value may be configured to an upper limit value (e.g., 25 for 15 kHz SCS) of the number of RBs of the PDSCH that can be processed by the eRedCap terminal per slot, or may be configured to another value.

In this case, the total number of RBs included in the part of the group of RBs specified as the PDSCH reception resource may be equal to or less than the threshold value (e.g., 25).

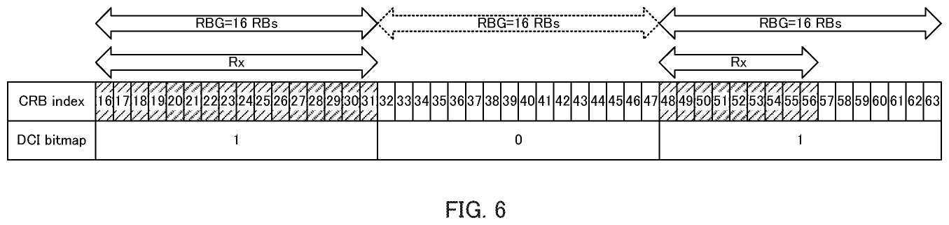

For example, terminal 200 may select 25 or less RBs among the RBs included in the indicated RBG in an order of low frequency (or RB index) and specify the selected RBs as the RBs for PDSCH reception. FIG. 6 is a diagram illustrating a configuration example of the RBs for PDSCH reception.

As illustrated in FIG. 6, two RBGs including a total of 32 RBs including an RBG including an RB index (e.g., common RB (CRB) index) #16 to #31 and an RBG including an RB index #48 to #63 are indicated to terminal 200. For example, as illustrated in FIG. 6, the information on the RBGs included in the DCI may be information in a bitmap format, and may indicate that the RBG corresponding to 0 is not allocated to terminal 200 and the RBG corresponding to 1 is allocated to terminal 200.

In FIG. 6, since the total number of the RBs (32) included in the indicated RBGs exceeds the threshold value (e.g., 25), terminal 200 determines (or specifies) 25 or less RBs from the 32 RBs as the RBs for PDSCH reception. In the example of FIG. 6, terminal 200 may select 25 RBs of the CRB index #16 to #31 and the CRB index #48 to #56 in an order of low frequency (e.g., CRB index) and specify the selected RBs as the RBs for PDSCH reception (e.g., represented by “Rx”).

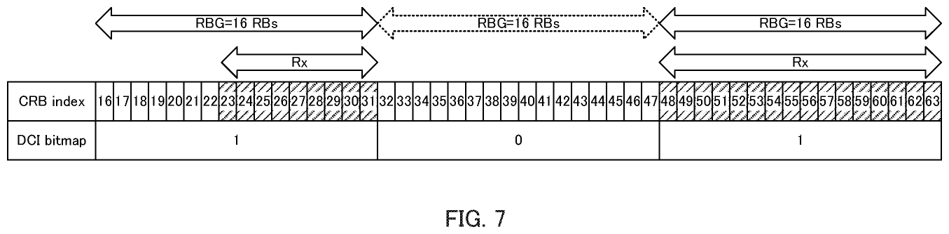

Note that the selection method of RBs for PDSCH reception is not limited thereto, and for example, terminal 200 may select 25 or less RBs among the RBs included in the indicated RBGs in an order of high frequency (or RB index) and specify the selected RBs as the RBs for PDSCH reception. FIG. 7 is a diagram illustrating a configuration example of the RB for PDSCH reception.

As illustrated in FIG. 7, two RBGs including a total of 32 RBs including an RBG including an RB index (e.g., CRB index) #16 to #31 and an RBG including an RB index #48 to #63 are indicated to terminal 200. In FIG. 7, since the total number of the RBs (32) included in the indicated RBGs exceeds the threshold value (e.g., 25), terminal 200 determines (or specifies) 25 or less RBs from the 32 RBs as the RBs for PDSCH reception. In the example of FIG. 7, terminal 200 may select 25 RBs of the CRB index #63 to #48 and the CRB index #31 to #23 in an order of high frequency (e.g., CRB index) and specify the selected RBs as the RBs for PDSCH reception.

### S104

Base station 100, for example, maps and transmits data onto the PDSCH resource. Note that, base station 100 may map and transmit the data to the RBG configured for terminal 200 or may map and transmit the data to the RBs for the PDSCH determined according to the RBGs (e.g., the total number of RBs) configured for terminal 200 and the threshold value (e.g., the value based on the processing capability of terminal 200) as in the processing of S103 of terminal 200.

### S105

Terminal 200 receives the data on PDSCH by using the group of RBs (PDSCH reception resource) specified in S103.

According to Operation Example 1-1, even in a case where the total number of RBs included in the RBGs indicated from base station 100 is larger than the number of RBs suitable for the processing capability of terminal 200, terminal 200 can receive PDSCH by using the number of RBs suitable for the processing capability of terminal 200. Further, as illustrated in FIGS. 6 and 7, since terminal 200 can receive PDSCH by using the RBs distributed on the frequency axis, the received quality is improved by frequency diversity gain. Further, in Operation Example 1-1, since the selection method of RBs is simple, an increase in the amount of calculation processing in terminal 200 can be suppressed.

### Operation Example 1-2

The processing of base station 100 and terminal 200 in Operation Example 1-2 may be, for example, the same processing as the processing illustrated in FIG. 5. In Operation Example 1-2, the processing of S101, S102, S104, and S105 is the same as the processing in Operation Example 1-1, and the selection method of RBs in the processing of S103 is different from the selection method in Operation Example 1-1.

### S103

In a case where the total number of RBs included in the RBGs (e.g., the plurality of RBGs configured for terminal 200) indicated in S102 is larger than the threshold value (e.g., 25) (e.g., in a case of exceeding the threshold value), terminal 200 determines (or configures, specifies) a part of the group of RBs of the indicated RBGs as the PDSCH reception resource.

In this case, the total number of RBs included in the part of the group of RBs specified as the PDSCH reception resource may be equal to or less than the threshold value (e.g., 25).

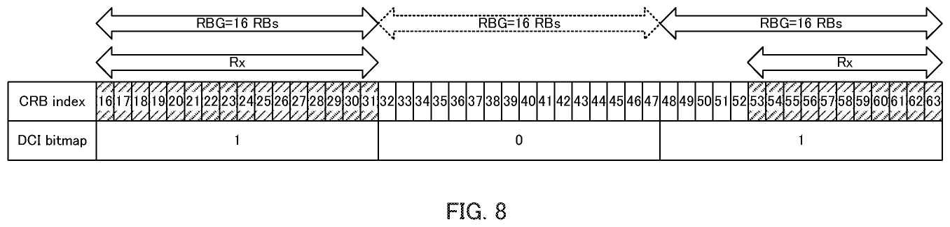

For example, terminal 200 may select 25 or less RBs including the RB having the lowest frequency (or RB index) and the RB having the highest frequency (or RB index) among the RBs included in the indicated RBGs, and specify the selected RBs as the RBs for PDSCH reception. FIG. 8 is a diagram illustrating a configuration example of RBs for PDSCH reception.

As illustrated in FIG. 8, two RBGs including a total of 32 RBs including an RBG including the RB index (e.g., a CRB index) #16 to #31 and an RBG including the RB index #48 to #63 are indicated to terminal 200.

In FIG. 8, since the total number of the RBs (32) included in the indicated RBGs exceeds the threshold value (e.g., 25), terminal 200 determines (or specifies) 25 or less RBs from the 32 RBs as the RBs for PDSCH reception. In the example of FIG. 8, terminal 200 may select a group of 25 RBs including the CRB index #16 having the lowest frequency (e.g., CRB index) and the CRB index #63 having the highest frequency (e.g., CRB index) among the indicated RBGs and specify the selected group of RBs as the RBs for PDSCH reception (e.g., represented by “Rx”). In the example of FIG. 8, the CRB index #16 to #31 and the CRB index #53 to #63 are selected as the RBs for PDSCH reception.

Noted that, in FIG. 8, the RBs selected as the RBs for PDSCH reception are not limited to the CRB index #17 to #31 and #53 to #62 in addition to the CRB index #16 and #63, and may be other RBs.

According to Operation Example 1-2, even in a case where the total number of RBs included in the RBGs indicated from base station 100 is larger than the number of RBs suitable for the processing capability of terminal 200, terminal 200 can receive PDSCH by using the number of RBs suitable for the processing capability of terminal 200. Further, as illustrated in FIG. 8, since terminal 200 can receive PDSCH by using the RBs distributed on the frequency axis, the received quality is improved by frequency diversity gain. Further, in Operation Example 1-2, since the value range of the frequency of the RBs selected as the RBs for PDSCH reception is wide, the frequency diversity gain is large as compared with Operation Example 1-1.

Exemplary operations of base station 100 and terminal 200 have been described above.

As described above, in the present embodiment, terminal 200 determines the RBs distributedly mapped on the frequency axis among a plurality of RBs obtained by dividing the frequency band (e.g., BWP) as the PDSCH reception resource. In this case, the number of RBs included in the PDSCH reception resource is equal to or less than the threshold value (e.g., value based on the processing capability of terminal 200). For example, in a case where the total number of RBs included in a plurality of RBGs configured for terminal 200 is larger than the threshold value, terminal 200 determines RBs in an RBG that are equal to or less than the threshold value as the PDSCH reception resource. Then, terminal 200 receives the PDSCH signal by using the PDSCH reception resource.

As a result, terminal 200 can flexibly configure (or specify) RBs for PDSCH reception according to the processing capability of terminal 200. Further, since a group of non-consecutive RBs can be allocated as the RBs for PDSCH reception, the received quality can be improved by frequency diversity gain.

As described above, according to the present embodiment, the downlink resource allocation can be appropriately configured.

### Summary of Embodiment 1

In Embodiment 1, the operation examples in a case where the total number of RBs included in the RBGs indicated to terminal 200 exceeds the threshold value (e.g., 25) have been described. Meanwhile, in a case where the total number of RBs included in the RBGs indicated to terminal 200 is equal to or less than the threshold value, terminal 200 may receive PDSCH by using all the RBs included in the indicated RBGs.

Further, in the present embodiment (or embodiment described later), the “threshold value” may be derived based on the processing capability of terminal 200. For example, the threshold value may be configured to 25 or less for 15 kHz SCS and 12 or less for 30 kHz SCS based on the processing capability of the eRedCap terminal.

Alternatively, the “threshold value” may be derived based on an identification number of terminal 200 or the like. For example, the threshold value may be derived based on a terminal-specific number, such as a cell-radio network temporary identity (C-RNTI) or a cell ID.

Alternatively, the “threshold value” may be defined in advance or may be indicated (or configured) to terminal 200 by a control signal (e.g., radio resource control (RRC), medium access control (MAC), or DCI).

Alternatively, the “threshold value” may be derived based on more than two of the processing capability of terminal 200, the identification number of terminal 200 or the like, the defined value, and the indicated value.

Further, in the present embodiment (or embodiment described later), the method of selecting a group of RBs by terminal 200 may be specified based on the processing capability of terminal 200 or the identification number of terminal 200 or the like, may be defined in advance, or may be indicated to terminal 200 by a control signal (e.g., at least one of RRC, MAC, or DCI). Alternatively, the threshold value may be specified by a combination of these methods.

Further, in the present embodiment, the case where a group of RBs consecutive on the frequency axis is selected in each RBG has been described, but a group of RBs may be selected by another method. For example, a group of non-consecutive RBs may be selected on the frequency axis in each RBG, and the intervals between these RBs on the frequency axis may be equal or unequal. Further, for example, the RBs for PDSCH reception may be uniformly configured in a plurality of RBGs configured for terminal 200.

### Embodiment 2

Base station 100 and terminal 200 according to the present embodiment may be the same as those in Embodiment 1.

In the present embodiment, terminal 200 specifies “sub-RBG” that is a part of the RBs included in each RBG in each of a plurality of RBGs indicated from base station 100, as a resource used for PDSCH reception. In this case, a parameter related to the sub-RBG may be indicated to terminal 200 or may be defined in advance. According to the present embodiment, RBs can be used more flexibly.

Hereinafter, an operation example of base station 100 and terminal 200 according to the present embodiment will be described.

### Operation Example 2-1

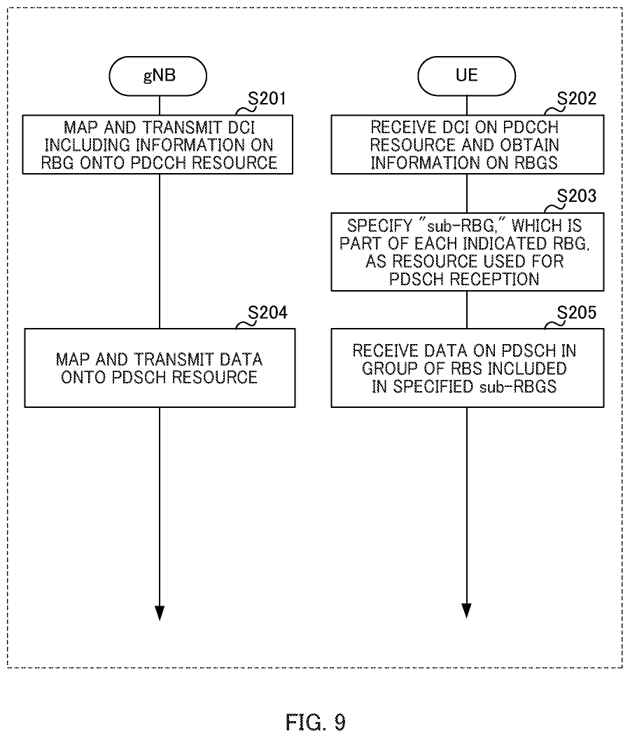

FIG. 9 is a flowchart illustrating an example of processing of base station 100 (e.g., gNB) and terminal 200 (e.g., UE).

### S201

Base station 100, for example, maps and transmits a DCI including information on RBGs onto a PDCCH resource (e.g., the same as S101 of Embodiment 1).

### S202

Terminal 200 receives, for example, the DCI on the PDCCH resource to obtain the information on the RBGs (e.g., the same as S102 of Embodiment 1).

### S203

Terminal 200 determines (or configures, specifies) a sub-RBG that is a part of the RBs included in each of the plurality of RBGs indicated in S202 as the PDSCH reception resource.

For example, terminal 200 may specify a sub-RBG of each RBG based on the parameter related to the sub-RBG. The parameter related to the sub-RBG may include, for example, an “offset” and a “size”. The offset may be, for example, a value for specifying the number of RBs from a defined position (e.g., an end (or top (or first)) of RBG) of each RBG to the sub-RBG (e.g., position of the end of the sub-RBG). The size may be, for example, a value for specifying the number of RBs constituting the sub-RBG.

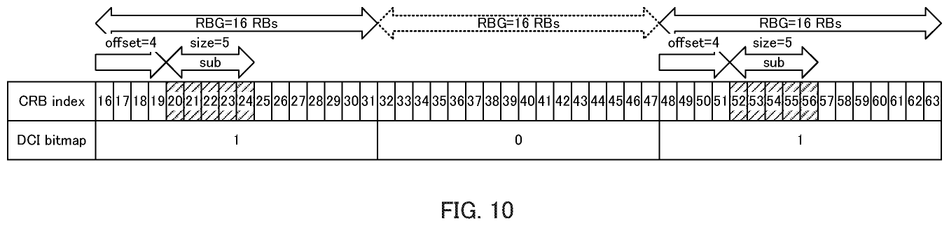

FIG. 10 is a diagram illustrating a configuration example of RBs for PDSCH reception.

As illustrated in FIG. 10, two RBGs including a total of 32 RBs including an RBG including the RB index #16 to #31 and an RBG including the RB index #48 to #63 are indicated to terminal 200. Further, in FIG. 10, the offset of the sub-RBG is 4 RBs, and the size is 5 RBs.

In FIG. 10, terminal 200 specifies, for example, five RBs (CRB index #20 to #24) starting from the CRB index #16+4=#20 for the RBG including the RB index #16 to #31 as the sub-RBG (e.g., also represented by “sub”). Similarly, in FIG. 10, terminal 200 specifies, for example, five RBs (CRB index #52 to #56) starting from the CRB index #48+4=#52 for the RBG including the RB index #48 to #63 as the sub-RBG. Therefore, in FIG. 10, terminal 200 specifies the sub-RBG of the CRB index #20 to #24 and the sub-RBG of the CRB index #52 to #56 as the RBs for PDSCH reception.

### S204

Base station 100, for example, maps and transmits data onto the PDSCH resource (e.g., the same as S104 of Embodiment 1). Note that, base station 100 may map and transmit the data to the RBGs configured for terminal 200 or may map and transmit the data to the RBs for PDSCH determined according to the RBGs (e.g., the total number of RBs) configured for terminal 200 and the threshold value (e.g., value based on the processing capability of terminal 200) as in the processing of S103 of terminal 200.

### S205

Terminal 200 receives the data on PDSCH by using a group of RBs (PDSCH reception resource) included in the sub-RBGs specified in S203.

According to Operation Example 2-1, the number of RBs and the RB position in the RBGs can be flexibly configured, and terminal 200 can receive PDSCH by using the RBs that are flexibly configured. Further, as illustrated in FIG. 10, since terminal 200 can receive PDSCH by using the RBs distributed on the frequency axis, the received quality is improved by frequency diversity gain. Further, in Operation Example 2-1, since the number of parameters related to the sub-RBGs is relatively small, an increase in the overhead of the control signal can be suppressed.

Note that, in FIG. 10, the method of specifying a sub-RBG based on the RB having a low frequency (or low CRB index) in each RBG has been described, but the present disclosure is not limited thereto, and for example, the sub-RBG may be specified based on the RB having a high frequency (or high CRB index).

### Operation Example 2-2

In Operation Example 2-2, for example, each RBG may include a plurality of sub-RBGs.

The processing of base station 100 and terminal 200 in Operation Example 2 -2 may be, for example, the same processing as the processing illustrated in FIG. 9. In Operation Example 2-2, the processing of S201, S202, S204, and S205 is the same as the processing in Operation Example 2-1, and the selection method of RBs in the processing of S203 is different from the selection method in Operation Example 2-1.

### S203

Terminal 200 determines (or configures, specifies) a sub-RBG that is a part of the RBs included in each of a plurality of RBGs indicated in S202 as the PDSCH reception resource.

For example, terminal 200 may specify a sub-RBG of each RBG based on the parameter related to the sub-RBG. The parameter related to the sub-RBG may include, for example, an “offset”, a “size”, and an “interval”. The offset may be, for example, a value for specifying the number of RBs from a defined position (e.g., an end (or top (or first)) of the RBG) of each RBG to the top (or first) of the sub-RBG (e.g., a position of the end of the sub-RBG). The size may be, for example, a value for specifying the number of RBs constituting the sub-RBG. The interval may be, for example, a value for specifying a distance (e.g., the number of RBs) between a plurality of sub-RBGs in each RBG.

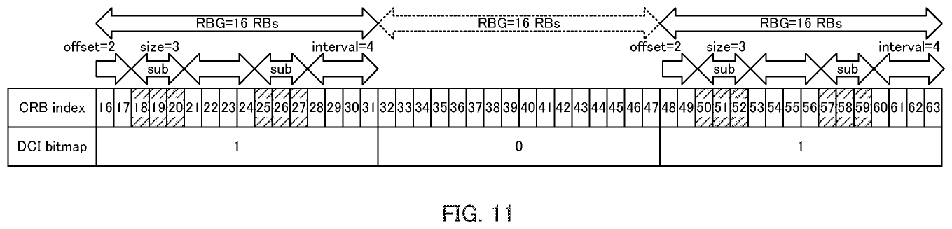

FIG. 11 is a diagram illustrating a configuration example of RBs for PDSCH reception.

As illustrated in FIG. 11, two RBGs including a total of 32 RBs including an RBG including the RB index #16 to #31 and an RBG including the RB index #48 to #63 are indicated to terminal 200. Further, in FIG. 11, the offset of the sub-RBG is 2 RBs, the size is 3 RBs, and the interval is 4 RBs.

In FIG. 11, terminal 200 specifies, for example, three RBs (CRB index #18 to #20) starting from the CRB index #16+2=#18 for the RBG including the RB index #16 to #31, as a first sub-RBG (e.g., also represented by “sub”), and specifies three RBs (CRB index #25 to #27) starting from the CRB index #25 separated by 4 RBs from the first sub-RBG (e.g., CRB index #20), as a second sub-RBG.

Similarly, in FIG. 11, terminal 200 specifies, for example, three RBs (CRB index #50 to #52) starting from the CRB index #48+2=#50 for the RBG including the RB index #48 to #63, as a first sub-RBG (e.g., also represented by “sub”), and specifies three RBs (CRB index #57 to #59) starting from the CRB index #57 separated by 4 RBs from the first sub-RBG (e.g., CRB index #52), as a second sub-RBG.

As described above, terminal 200 specifies the first sub-RBG based on the offset and the size from the top (or first) RB for each RBG, and specifies the second sub-RBG based on the interval and the size from the first sub-RBG. Note that, terminal 200 may repeatedly specify a third or subsequent sub-RBG based on the interval and the size until the end of the RBG in the same manner.

Note that, in FIG. 11, the method of specifying a sub-RBG based on the RB having a low frequency (or low CRB index) has been described, but the present disclosure is not limited thereto, and for example, the sub-RBG may be specified based on the RB having a high frequency (or high CRB index).

According to Operation Example 2-2, the number of RBs and the RB position in the RBG can be flexibly configured, and terminal 200 can receive PDSCH by using the RBs that are flexibly configured. Further, as illustrated in FIG. 11, since terminal 200 can receive PDSCH by using the RBs distributed on the frequency axis, the received quality is improved by frequency diversity gain. Further, in Operation Example 2-2, since the RBs for PDSCH reception are distributed to the plurality of sub-RBGs in each RBG, the frequency diversity gain may be larger than that in Operation Example 2-1.

### Operation Example 2-3

In Operation Example 2-3, for example, each RBG may include a plurality of sub-RBGs. Further, in Operation Example 2-3, for example, terminal 200 specifies the RBs for PDSCH reception based on the “number” of sub-RBGs included in each RBG.

The processing of base station 100 and terminal 200 in Operation Example 2-3 may be, for example, the same processing as the processing illustrated in FIG. 9. In Operation Example 2-3, the processing of S201, S202, S204, and S205 is the same as the processing in Operation Example 2-1, and the selection method of RBs in the processing of S203 is different from the selection method in Operation Example 2-1.

### S203

Terminal 200 determines (or configures, specifies) a sub-RBG that is a part of the RBs included in each of a plurality of RBGs indicated in S202 as the PDSCH reception resource.

For example, terminal 200 may specify a sub-RBG of each RBG based on the parameter related to the sub-RBG. The parameter related to the sub-RBG may include, for example, an “offset”, a “size”, an “interval”, and a “number”. The offset may be, for example, a value for specifying the number of RBs from a defined position (e.g., an end (or top (or first)) of the RBG) of each RBG to the top (or first) of the sub-RBG (e.g., a position of the end of the sub-RBG). The size may be, for example, a value for specifying the number of RBs constituting the sub-RBG. The interval may be, for example, a value for specifying a distance (e.g., the number of RBs) between a plurality of sub-RBGs in each RBG. The number may be, for example, a value for specifying the number of sub-RBGs in each RBG.

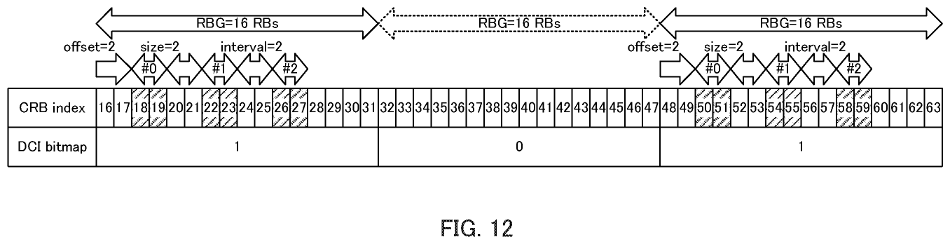

FIG. 12 is a diagram illustrating a configuration example of the RBs for PDSCH reception.

As illustrated in FIG. 12, two RBGs including a total of 32 RBs including an RBG including the RB index #16 to #31 and an RBG including the RB index #48 to #63 are indicted to terminal 200. Further, in FIG. 12, the offset of the sub-RBG is 2 RBs, the size is 2 RBs, the interval is 2 RBs, and the number is 3.

In FIG. 12, terminal 200 specifies, for example, three sub-RBGs for the RBG including the RB index #16 to #31. For example, terminal 200 specifies two RBs (CRB index #18 to #19) starting from the CRB index #16+2=#18 as a first sub-RBG (e.g., sub-RBG #0), specifies two RBs (CRB index #22 to #23) starting from the CRB index #22 separated by 2 RBs from the sub-RBG #0 (e.g., CRB index #19) as a second sub-RBG (e.g., sub-RBG #1), and specifies two RBs (CRB index #26 to #27) starting from the CRB index #26 separated by 2 RBs from the sub-RBG #1 (e.g., CRB index #23) as a third sub-RBG (e.g., sub-RBG #2).

Similarly, in FIG. 12, terminal 200 specifies, for example, three sub-RBGs for the RBG including the RB index #48 to #63. For example, terminal 200 specifies two RBs (CRB index #50 to #51) starting from the CRB index #48+2=#50 as a first sub-RBG (e.g., sub-RBG #0), specifies two RBs (CRB index #54 to #55) starting from the CRB index #54 separated by 2 RBs from the sub-RBG #0 (e.g., CRB index #51) as a second sub-RBG (e.g., sub-RBG #1), and specifies two RBs (CRB index #58 to #59) starting from the CRB index #58 separated by 2 RBs from the sub-RBG #1 (e.g., CRB index #55) as a third sub-RBG (e.g., sub-RBG #2).

According to Operation Example 2-3, the number of RBs and the RB position in the RBG can be flexibly configured, and terminal 200 can receive PDSCH by using the RBs that are flexibly configured. Further, as illustrated in FIG. 12, since terminal 200 can receive PDSCH by using the RBs distributed on the frequency axis, the received quality is improved by frequency diversity gain. Further, in Operation Example 2-3, since the RBs for PDSCH reception are distributed to the plurality of sub-RBGs in each RBG, the frequency diversity gain may be larger than that in Operation Example 2-1.

Further, in Operation Example 2-3, the number of sub-RBGs included in the RBG can be configured more finely than in Operation Example 2-2, and the flexibility of the resource allocation (RB allocation) can be improved.

Note that, in FIG. 12, the method of specifying a sub-RBG based on the RB having a low frequency (or low CRB index) has been described, but the present disclosure is not limited thereto, and for example, the sub-RBG may be specified based on the RB having a high frequency (or high CRB index).

The operation examples of base station 100 and terminal 200 have been described above.

As described above, in the present embodiment, terminal 200 determines RBs that are distributedly mapped on the frequency axis among a plurality of RBs obtained by dividing a frequency band (e.g., BWP) as a PDSCH reception resource. In this case, the number of RBs included in the PDSCH reception resource may be, for example, equal to or less than the number based on the processing capability of terminal 200. For example, terminal 200 determines the part of RBs (sub-RBG) of the RBs included in each of the plurality of RBGs configured for terminal 200 as the PDSCH reception resource. Then, terminal 200 receives the PDSCH signal by using the PDSCH reception resource.

As a result, terminal 200 can flexibly configure (or specify) the RBs for PDSCH reception according to the processing capability of terminal 200. Further, since a group of non-consecutive RBs can be allocated as the RBs for PDSCH reception, the received quality can be improved by frequency diversity gain.

As described above, according to the present embodiment, the downlink resource allocation can be appropriately configured.

### Summary of Embodiment 2

Note that, in the present embodiment, the same value (or common value) may be applied to all the RBGs included in BWP for each of “offset”, “size”, “interval”, and “number” that are the parameters of the sub-RBGs. As a result, the overhead of the control signal or the like for indicating the parameters can be reduced.

Alternatively, different values may be applied to each of “offset”, “size”, “interval”, and “number” that are the parameters of the sub-RBGs between a plurality (e.g., a part or all) of the RBGs included in BWP. As a result, terminal 200 can use the RBs more flexibly.

Further, in the present embodiment, each parameter of the sub-RBGs may be specified based on the processing capability of terminal 200 or the identification number of terminal 200 or the like, may be defined in advance, or may be indicated (or configured) to terminal 200 by a control signal (e.g., RRC, MAC, or DCI). Alternatively, each parameter of the sub-RBGs may be specified by a combination of these methods.

For example, an individual value (e.g., a value different between terminals 200) may be configured in the parameters of the sub-RBGs for terminal 200. As a result, a collision of the PDSCH resource between terminals 200 can be avoided.

Further, in the present embodiment, in a case where the total number of RBs included in a sub-RBG specified by terminal 200 exceeds the threshold value (e.g., the value based on the processing capability of terminal 200), terminal 200 may further specify a part of the group of RBs of the RBs included in the specified sub-RBG in the same manner as in Embodiment 1. In this case, the total number of RBs included in the specified group of RBs is a value equal to or less than the threshold value. As a result, terminal 200 can use, for example, the number of RBs appropriately processible according to the processing capability of terminal 200.

Further, in the present embodiment, the same value may be applied to a certain combination (or group) of parameters related to a sub-RBG. For example, both values of “offset” and “interval” may be configured to the same value. As a result, the overhead of the control signal or the like for indicating the parameters related to sub-RBG can be reduced.

### Summary of Embodiment 1 and Embodiment 2

The other RBs (e.g., an RB that is not a PDSCH reception resource) different from the group of RBs specified by terminal 200 for receiving PDSCH among the RBGs indicated to terminal 200 may be reused for other applications different from the PDSCH reception of terminal 200.

For example, the other RBs may be reused for the following applications.
Transmission and reception of electromagnetic waves for radio power feeding (e.g., for a device equipped with a small-capacity battery, a batteryless device, an Ambient IoT device, and the like)
Transmission and reception of downlink or uplink reference signals
Transmission and reception of a physical broadcast channel (PBCH) or a PDCCH
Transmission and reception of an uplink channel (e.g., PUSCH, PUCCH, or PRACH)
Muting (e.g., not transmitted on the resource, for example, for interference measurement or the like)
Transmission and reception by another terminal different from terminal 200 (e.g., a wake-up signal or the like)

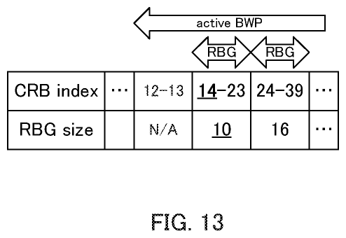

Further, in each of the above-described embodiments, at least one of the start RB index and the size of the RBG having the lowest frequency (or RBG having the highest frequency) in the BWP may be indicated to terminal 200 by a control signal or the like. For example, as illustrated in FIG. 13, at least one of the start RB index=14 of the first RBG (e.g., RBG having the lowest frequency) and the RBG size=10 of the BWP (e.g., active BWP) may be indicated (or configured) to terminal 200. As a result, it is possible to use RBs or RBGs more flexibly.

Here, RBs (in the example of FIG. 13, RB #12 and #13) that do not belong to RBGs in the BWP may be reused for other applications different from the PDSCH reception of terminal 200. An example of the reuse of the RBs that do not belong to the RBGs may be the same as the above-described example.

### Embodiment 3

Base station 100 and terminal 200 according to the present embodiment may be the same as those in Embodiment 1.

In the present embodiment, at least one of the start RB index and the RBG size of the RBG having the lowest frequency (or the highest frequency) in the BWP is indicated (or configured) to terminal 200. For example, terminal 200 may determine the PDSCH reception resource based on at least one of the start RB position and the RBG size of any one of the RBG having the lowest frequency and the RBG having the highest frequency (e.g., the first RBG) in the BWP configured for terminal 200.

Further, in this case, the total number of RBs included in the first RBG configured for terminal 200 and included in another RBG different from the first RBG is equal to or less than a defined number. The defined number may be, for example, a value according to the processing capability of terminal 200.

As a result, the number of RBs of PDSCH used by terminal 200 for receiving the PDSCH can match the defined number (e.g., the number corresponding to the processing capability of eRedCap terminal) by indicating the RBG for which at least one of the start RB index and the RBG size is indicated and the other RBG.

### Operation Example 3-1

In Operation Example 3-1, at least one of the start RB index and the RBG size of the RBG having the lowest frequency in the BWP is indicated (or configured) to terminal 200.

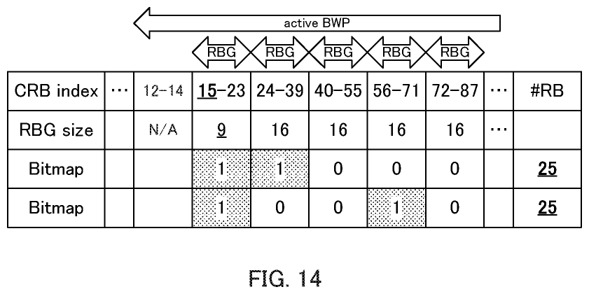

For example, as illustrated in FIG. 14, the start RB index=15 of the RBG (CRB index #15 to #23) having the lowest frequency and the RBG size=9 in the BWP (e.g., the active BWP) may be configured for terminal 200.

Further, in this case, as illustrated in FIG. 14, the total number of the RBs included in the RBG in which the start RB index and the RBG size are configured and the other RBG configured for terminal 200 is equal to or less than a defined number (e.g., the number according to the processing capability of terminal 200, e.g., 25) is configured.

For example, the two allocations of the RBG having the lowest frequency in the BWP and another RBG may be indicated to terminal 200. As a result, terminal 200 specifies a group of 25 RBs as the PDSCH reception resource. Terminal 200 receives PDSCH by using the specified group of RBs.

According to the present embodiment, the total number of RBs of the RBG for which at least one of the start RB index and the RBG size is configured and another RBG is configured to match the defined value. As a result, terminal 200 can receive PDSCH by using the number of RBs suitable for the processing capability of terminal 200.

Note that, as in Embodiment 2, a sub-RBG may be configured in an RBG. As a result, it is possible to use RBs more flexibly.

Further, at least one of the start RB index and the RBG size of the RBG having the lowest frequency (or the highest frequency) in the BWP may be specified based on the processing capability of terminal 200 or the identification number of terminal 200 or the like, may be defined in advance, or may be indicated to terminal 200 by a control signal (e.g., RRC, MAC, or DCI).

Further, the RBs (in the example of FIG. 14, RB #12 to #14) that do not belong to the RBG in the BWP may be reused for other applications different from the PDSCH reception of terminal 200. An example of the reuse of the RBs that do not belong to the RBG may be the same as the above-described example.

Further, the RBG for which at least one of the start RB index and the RBG size is indicated (or configured) to terminal 200 is not limited to the RBG having the lowest frequency or the highest frequency in the BWP and may be another RBG. Which one of the RBGs in the BWP is the RBG for which at least one of the start RB index and the RBG size is indicated (or configured) to terminal 200 may be specified based on the processing capability of terminal 200 or the identification number of terminal 200 or the like, may be defined in advance, or may be indicated to terminal 200 by a control signal (e.g., RRC, MAC, or DCI).

### Embodiment 4

Base station 100 and terminal 200 according to the present embodiment may be the same as those in Embodiment 1.

In the present embodiment, at least one of the RBG size and the number of RBGs is indicated (or configured) to terminal 200. For example, terminal 200 specifies a plurality of RBGs in the BWP based on information on at least one of the number of RBGs and the RBG size. In this case, the total number of RBs included in the plurality of RBGs is smaller than the total number of RBs included in the BWP. According to the present embodiment, since the number of RBs included in the RBG is smaller than the total number of RBs in the BWP, the overhead of the control signal used for the indication of the RBG can be reduced.

### Operation Example 4-1

In Operation Example 4-1, information on at least one of the RBG size and the number of RBGs is indicated (or configured) to terminal 200. In this case, the total number of RBs included in the plurality of RBGs specified by the information is smaller than the total number of RBs included in the BWP.

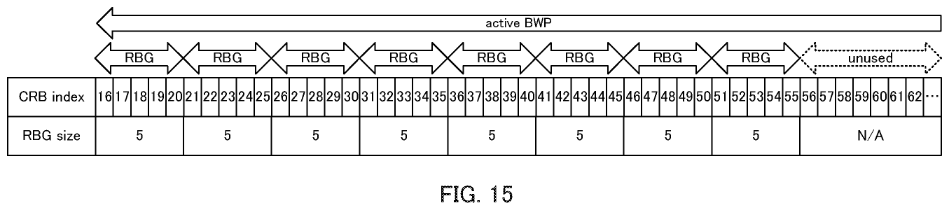

FIG. 15 illustrates a configuration example of the RBG according to Operation Example 4-1.

In FIG. 15, the total number of RBs included in the BWP is 106. In FIG. 15, the RBG size=5 and the number of RBGs=8 are indicated (or configured). In the example of FIG. 15, the total number of RBs included in all the RBGs is 40, which is smaller than the total number of RBs included in the BWP, which is 106.

Further, in the example of FIG. 15, the plurality of RBGs is continuously configured on the frequency without leaving an offset or a gap (spacing).

The RBGs based on the configuration may be indicated to terminal 200. For example, in a case where the RBGs configured for terminal 200 is indicated by a bitmap in units of RBGs, the bitmap information is 8 bits in the example of FIG. 15. For example, five RBGs (e.g., 25 RBs) of the eight RBGs illustrated in FIG. 15 may be configured for terminal 200. Terminal 200 specifies the group of RBs included in the indicated RBGs as the RBs for PDSCH reception. Further, terminal 200 receives PDSCH by using the specified group of RBs. Note that the method of specifying the RBs for PDSCH reception may be any of Embodiment 1 and Embodiment 2.

As a result, the amount of information (e.g., the number of bits) used for the indication of RBGs can be reduced as compared with a case where the RBGs are configured in the entire BWP, so that the overhead of the control signal used for the indication of RBGs can be suppressed, and RBGs can be used flexibly. Further, in Operation Example 4-1, the overhead of the control signal can be reduced by the amount obtained by eliminating the need for configuring the offset and the spacing.

### Operation Example 4-2

Operation Example 4-2 is different from Operation Example 4-1 in that a plurality of RBGs is configured with at least one of the offset and the spacing.

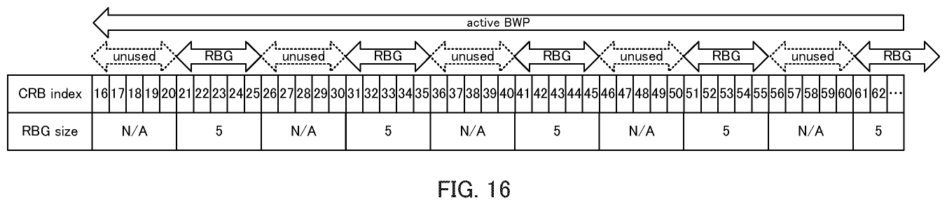

FIG. 16 illustrates a configuration example of RBGs according to Operation Example 4-2.

In FIG. 16, the total number of RBs included in the BWP is 106. As illustrated in FIG. 16, the RBG size=5 and the number of RBGs=8 (partially illustrated) are indicated (or configured). Further, in FIG. 16, the offset=5 and the spacing=5 may be indicated (or configured) to terminal 200.

In the example of FIG. 16, the total number of RBs included in all the RBGs configured in terminal 200 is 40, which is smaller than the total number of RBs included in the BWP, which is 106.

Further, in the example of FIG. 16, eight RBGs of the RBG size=5 RBs are configured from the RB (CRB index #21) shifted by the offset=5 RBs from the end of the BWP, with the spacing=5 RBs. That is, a plurality of RBGs is non-consecutively configured on the frequency.

The RBGs based on the configuration may be indicated to terminal 200. For example, in a case where the RBGs configured for terminal 200 is indicated by a bitmap in units of RBGs, the bitmap information is 8 bits in the example of FIG. 16. For example, five RBGs (e.g., 25 RBs) of the eight RBGs illustrated in FIG. 16 may be configured for terminal 200. Terminal 200 specifies the group of RBs included in the indicated RBGs as the RBs for PDSCH reception. Further, terminal 200 receives PDSCH by using the specified group of RBs. Note that the method of specifying the RBs for PDSCH reception may be any of Embodiment 1 and Embodiment 2.

As a result, the amount of information (e.g., the number of bits) used for the indication of the RBGs can be reduced as compared with a case where the RBGs are configured in the entire BWP, so that the overhead of the control signal used for the indication of the RBGs can be suppressed, and the RBGs can be used flexibly. Further, in Operation Example 4-2, the configuration of the offset or the spacing makes it possible to configure the RBGs flexibly as compared with Operation Example 4-1, and the RBGs are distributed on the frequency axis, so that the frequency diversity gain is large.

### Summary of Embodiment 4

Note that as in Embodiment 2, a sub-RBG may be configured in the RBGs. As a result, it is possible to use the RBs more flexibly.

Further, at least one of the RBG size, the number of RBGs, the offset, and the spacing may be specified based on the processing capability of terminal 200 or the identification number of terminal 200 or the like, may be defined in advance, or may be indicated to terminal 200 by a control signal (e.g., RRC, MAC, or DCI).

Further, the RBs (in the examples of FIGS. 15 and 16, the RBs corresponding to unused) that do not belong to the RBGs in the BWP may be reused for other applications different from the PDSCH reception of terminal 200. An example of the reuse of the RBs that do not belong to the RBGs may be the same as the above-described example.

### Embodiment 5

Base station 100 and terminal 200 according to the present embodiment may be the same as those in Embodiment 1.

In the present embodiment, a plurality of resource indication values (RIVs) is indicated to terminal 200. Terminal 200 determines the PDSCH reception resource based on the plurality of RIVs indicated to terminal 200, for example. As a result, the RBGs can be distributedly configured on the frequency axis, so that the received quality of PDSCH is improved by frequency diversity gain.

### Operation Example 5-1

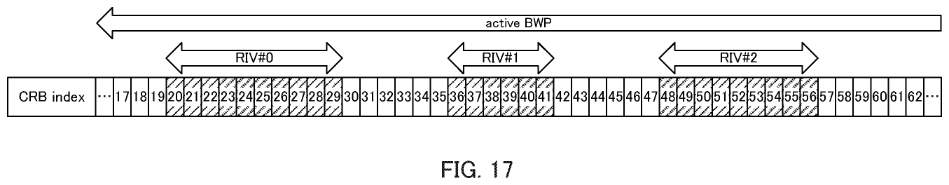

A plurality of RIVs may be indicated to terminal 200. For example, as illustrated in FIG. 17, three RIVs of an RIV #0 indicating the RB #20 to 29, an RIV #1 indicating the RB #36 to 41, and an RIV #2 indicating the RB #48 to 56 may be indicated to terminal 200.

Terminal 200 specifies the RBs (e.g., 25 RBs) used for receiving PDSCH based on the indicated RIVs and receives the PDSCH.

Note that the configuration of the RIVs illustrated in FIG. 17 is an example, and the number of RIVs is not limited to three and may be two or four or more.

Configuring a plurality of RIVs makes it possible to flexibly configure or use the number of RBs and makes the frequency diversity gain larger.

Note that the number and the values of RIVs may be specified based on the processing capability of terminal 200 or the identification number of terminal 200 or the like, may be defined in advance, or may be indicated to terminal 200 by a control signal (RRC, MAC, or DCI).

The embodiments of the present disclosure have been described above.

### Other Embodiments

Note that the RBs allocated to terminal 200 are not limited to the RBs distributedly mapped on the frequency axis and may be RBs (e.g., consecutive RBs) not distributedly mapped on the frequency axis. Terminal 200 may determine, for example, the RBs not distributedly mapped on the frequency axis as the PDSCH reception resource.

### DCI for eRedCap Terminal

In each of the above-described embodiments, the eRedCap terminal may specify that a payload size of an RIV included in a DCI indicated to the eRedCap terminal is smaller than a payload size of an RIV included in another DCI.

For example, in a case where the SCS is 15 kHz and the total number of RBs included in the BWP is 106, it is desirable that an RIV in a DCI (e.g., DCI carried by common search space) that is commonly indicated to all the terminals corresponds to all the cases where the number of RBs is 1 to 106. Meanwhile, an RIV in a DCI (e.g., DCI carried by UE-specific search space) that is indicated to the eRedCap terminal may correspond to, for example, the case where the number of RBs is 1 to 25. Therefore, the RIV included in the DCI that is indicated to an eRedCap terminal is smaller in payload size than the RIV included in the DCI that is commonly indicated to all the terminals.

The eRedCap terminal may receive PDCCH in consideration of the fact that the payload size of the RIV included in the DCI that is indicated to the eRedCap terminal is relatively small. The eRedCap terminal may specify the RBs for PDSCH reception and receive PDSCH after receiving the RIV.

As described above, since the payload size of the RIV in the DCI that is indicated to the eRedCap terminal is relatively small, the overhead of the control signal can be suppressed.

The configuration of the payload size of the RIV is not limited to a case where the PDSCH reception resource of the eRedCap terminal is the RBs distributedly mapped on the frequency axis and may be applied to a case where the PDSCH reception resource is the RBs not distributedly mapped on the frequency axis (e.g., consecutive RBs).

Further, the configuration of the payload size of an RIV may be applied to any of a case where the number of RIVs configured for terminal 200 (e.g., eRedCap terminal) is one or a plurality.

### Indication of RBG and RIV

In each of the above-described examples, the examples have been described in which RBGs or RIVs of PDSCH are indicated by a DCI, but the present disclosure is not limited thereto, and RBGs or RIVs may be configured by a higher layer signal or the like. In this case, the resource indicated by the RBGs or the RIVs may be activated or deactivated by at least one of the DCI and the higher layer signal.

### RB and RB Index

Although the common resource block (CRB) has been described as the RB (RB index) used in each of the above-described embodiments, the present disclosure is not limited thereto, and for example, a physical RB (PRB), a virtual RB (VRB), or another type of RB may be used.

### BWP

The above-described embodiments may be applied to a case where the total number of RBs included in a BWP configured (configured BWP) or a BWP activated (active BWP) for a terminal is larger than the threshold value (e.g., the number of RBs of PDSCH that can be processed by terminal). For example, the above-described embodiments may be applied to a case where the BWP including the number of RBs larger than 25 or 12 is configured or activated in the terminal. As a result, even in a case where the BWP having a wide bandwidth is configured or activated, it is possible to appropriately assign PDSCH and to increase the frequency diversity gain by utilizing the wide bandwidth.

Note that the frequency bands (e.g., RBs) illustrated in FIGS. 6 to 8, 10 to 12, and 14 to 17 may be RBs constituting the entire BWP or may be a part of the RBs (that is, the other RBs are not illustrated) included in the BWP.

### Parameter Configuration

The values, such as parameters (e.g., the number of processible RBs per slot) related to the processing capability of the eRedCap terminal, the threshold value with respect to the number of RBs, the SCS, the parameters (e.g., size, number, offset, and interval) related to a sub-RBG, and the parameters (e.g., size, number, offset, and spacing) related to an RBG are merely examples, and other values may be used.

### Type, Kind, and Identification of Terminal

The above-described embodiments are assumed to be applied to, for example, an “eRedCap terminal”, but may be applied to other types of terminals. For example, the above-described embodiments may be applied to a RedCap terminal.

Note that in the above-described embodiments, the “eRedCap terminal” or “RedCap terminal” may be, for example, a terminal having at least one of the following features (e.g., properties, attributes, and capabilities).
(1) A terminal that indicates (e.g., reports) base station 100 that the terminal is a “RedCap terminal”, an “eRedCap terminal”, or a “terminal that is a target of coverage extension”. Or a terminal that indicates to (e.g., reports) base station 100 of information (e.g., UE feature or capability report) corresponding to RedCap or eRedCap. Note that, for the above-described indication (report), an uplink channel such as a PRACH or PUSCH or an uplink signal such as a Sounding Reference Signal (SRS) may be used, for example.
(2) A terminal having at least one of the following capabilities, or a terminal reporting at least one of the following capabilities to base station 100. Note that, for the above-described report, an uplink channel such as a PRACH or PUSCH or an uplink signal such as a UCI or SRS may be used, for example.
A terminal in which a transmittable and receivable frequency bandwidth (e.g., maximum value) is equal to or less than a threshold value (e.g., 20 MHz or less for RedCap terminal and 5 MHz or less for eRedCap terminal).
A terminal in which the number of transmittable and receivable resource blocks (e.g., maximum number) is equal to or less than a threshold value (e.g., 106/51 or less for RedCap terminal and 25/12 or less for eRedCap terminal with respect to 15/30 kHz SCS).
A terminal in which the number of installed reception antennas or the number of reception blocks is equal to or less than a threshold value (e.g., threshold value=1).
A terminal for which the number of supportable downlink ports (e.g., the number of reception antenna ports) is equal to or less than a threshold value (e.g., threshold value=2)
A terminal for which the number of supportable transmission ranks (e.g., the number of maximum Multiple-Input Multiple-Output (MIMO) layers (or the number of ranks)) is equal to or less than a threshold value (e.g., threshold value=2)
A terminal capable of transmitting and receiving a signal in a frequency band equal to or less than a threshold value (e.g., Frequency Range 1 (FR1) or a band equal to or less than 6 GHz in eRedCap)
A terminal for which the processing time is equal to or longer than a threshold value
A terminal for which the available transport block size (TBS) is equal to or smaller than a threshold value.
A terminal (e.g., terminal in which the threshold value=10 Mbps or a terminal of 10 Mbps or less in eRedCap) in which an available peak data rate is the same as or smaller than the threshold value.
A terminal for which the number of available transmission ranks (e.g., the number of MIMO transmission layers) is equal to or less than a threshold value.
A terminal for which the available modulation order is equal to or less than a threshold value
A terminal for which the number of available Hybrid Automatic Repeat reQuest (HARQ) processes is equal to or less than a threshold value.
A terminal that supports Rel-17 or later for RedCap terminals and a terminal that supports Rel-18 or later for eRedCap terminals.
   (3) A terminal to which a parameter supporting a RedCap terminal or an eRedCap terminal is indicated from base station 100. Note that the parameter supporting a RedCap terminal or an eRedCap terminal may include, for example, a parameter, such as Subscriber Profile ID for RAT/Frequency Priority (SPID).

Further, the above-described embodiments may be applied to a terminal of a type different from eRedCap and RedCap. For example, the same embodiment may be applied to a batteryless terminal or a terminal having an extremely small battery capacity (e.g., an Ambient IoT terminal) for which standardization is expected in Rel-19 or later. For example, it is assumed that the number of RBs of PDSCH processible in the Ambient IoT terminal is smaller than that in the eRedCap terminal.

### Application to Sub-Band Full-Duplex

The above-described embodiments assume a case where PDSCH is assigned to a slot and a symbol in which all RBs are configured to be used for downlink transmission and reception, but the above-described embodiments may be applied to a case where PDSCH is assigned to other types of slots or symbols. For example, the above-described embodiments may be applied to a slot or a symbol in which a part of RBs of the frequency resource (e.g., the BWP) is used for downlink transmission and reception. For example, the above-described embodiments may be applied to the PDSCH assignment in a sub-band full-duplex (SBFD) slot or symbol. In the SBFD slot or symbol, the frequency resource may be divided into a plurality of frequency bands (e.g., also referred to as subbands, an RB set, sub-bands, or sub-BWPs), and base station 100 may simultaneously perform downlink transmission and reception in one or a plurality of frequency bands and perform uplink transmission and reception in the remaining frequency bands. Terminal 200 may perform downlink reception in the frequency band for downlink and may perform neither transmission nor reception in the frequency band for uplink or may simultaneously perform uplink transmission. Alternatively, terminal 200 may perform uplink transmission in the frequency band for uplink and may perform neither transmission nor reception in the frequency band for downlink or may simultaneously perform downlink reception. Information, such as use of a certain slot or symbol for SBFD, a position, a bandwidth, and a transmission direction (uplink or downlink) of each frequency band may be indicated to terminal 200 by a control signal or the like.

For example, RBs or RBGs of PDSCH indicated in an SBFD slot may be present in both the downlink frequency band and another frequency band different from the downlink frequency band. In this case, for example, terminal 200 may specify the RBs used for PDSCH reception from among the RBs included in the downlink frequency band among the RBs indicated to terminal 200. In this case, the number of RBs specified by terminal 200 may be configured to a threshold value (e.g., maximum value based on processing capability of eRedCap terminal) or less.

### Application to Unlicensed Band and Shared Spectrum

Each of the above-described embodiments assumes a case where a channel access procedure (or listen before talk (LBT), carrier sense, or channel clear assessment (CCA)) is not required to be performed before the downlink transmission, but the above-described embodiments may be applied to a case where the channel access procedure is required to be performed before the downlink transmission, such as operation in a shared spectrum (e.g., unlicensed band). For example, the frequency resource (e.g., BWP) may be divided into a plurality of frequency bands (e.g., RB set), and the channel access procedure may be performed on each RB set. Terminal 200 may perform downlink reception in the RB set determined to be available from the result of the channel access procedure among the RB sets.

For example, RBs or RBGs of PDSCH indicated to terminal 200 may be present in both the RB set that is available and the RB set that is not available from the result of the channel access procedure. In this case, for example, terminal 200 may specify the RBs used for PDSCH reception from among the RBs included in the RB set determined to be available from the result of the channel access procedure among the RBs indicated to terminal 200. In this case, the number of RBs specified by terminal 200 may be configured to a threshold value (e.g., maximum value based on processing capability of eRedCap terminal) or less. Further, in this case, terminal 200 may determine, for example, the RBs distributedly mapped on the frequency axis or the RBs not distributedly mapped on the frequency axis as the PDSCH reception resource.

### Application to Broadcast, Groupcast, and Multicast

Each of the above-described embodiments assumes a case where PDSCH is assigned dedicatedly to a certain terminal 200, but the above-described embodiments may be applied to a case where the same PDSCH resource is assigned to a plurality of terminals as in broadcast, groupcast, and multicast. For example, for broadcast, groupcast, and multicast, the total number of RBs of PDSCH indicated may be larger than the threshold value (e.g., maximum value based on processing capability of eRedCap terminal). In this case, for example, terminal 200 may specify the RBs used for PDSCH reception from among the RBs indicated to terminal 200. In this case, the number of RBs specified by terminal 200 may be configured to a threshold value (e.g., maximum value based on processing capability of eRedCap terminal) or less. Further, in this case, terminal 200 may determine, for example, the RBs distributedly mapped on the frequency axis or the RBs not distributedly mapped on the frequency axis as the PDSCH reception resource.

Note that the broadcast, groupcast, and multicast may be, for example, a multicast PDSCH or a broadcast PDSCH in system information (SI), paging, message 2 (Msg2), random-access response (RAR), message 4 (Msg4), a contention resolution, message B (MsgB), fallback RAR, success RAR, or multicast-broadcast services (MBS). Further, these frequency resources of PDSCH may be indicated by, for example, a PDCCH scrambled by an SI-RNTI, P-RNTI, RA-RNTI, TC-RNTI, MsgB-RNTI, G-RNTI, G-CS-RNTI, or MCCH-RNTI.

### Supplement

Information indicating whether terminal 200 supports the functions, operations, or processes described in the above-described embodiments may be transmitted (or indicated) from terminal 200 to base station 100 as capability information or a capability parameter of terminal 200.

The capability information may include an information element (IE) individually indicating whether terminal 200 supports at least one of the functions, operations, or processes described in the above-described embodiments. Alternatively, the capability information may include an information element indicating whether terminal 200 supports a combination of any two or more of the functions, operations, or processes described in the above-described embodiments, modifications, and supplements.

Base station 100 may determine (or assume) the function, operation, or process supported (or not supported) by terminal 200 of the transmission source of the capability information, based on the capability information received from terminal 200, for example. Base station 100 may perform an operation, processing, or control according to a determination result based on the capability information. For example, base station 100 may control a downlink resource based on the capability information received from terminal 200.

Note that the fact that terminal 200 does not support some of the functions, operations, or processes described in the above-described embodiments may be read as that some of the functions, operations, or processes are limited in terminal 200. For example, information or a request on such limitation may be indicated to base station 100.

Information on the capability or limitation of terminal 200 may be defined, for example, in the standard, or may be implicitly indicated to base station 100 in association with information known to base station 100 or information transmitted to base station 100.

Control Signal

In the present disclosure, the downlink control signal (or downlink control information) relating to one exemplary embodiment of the present disclosure may be a signal (or information) transmitted in a Physical Downlink Control Channel (PDCCH) in a physical layer, for example, or may be a signal (or information) transmitted in a Medium Access Control Control Element (MAC CE) or Radio Resource Control (RRC) in a higher layer. Further, the signal (or information) is not limited to that indicated by the downlink control signal, but may be predefined in the specifications (or standard) or may be pre-configured for the base station and the terminal.

Furthermore, the PDCCH may be transmitted, for example, in either Common Search Space (CSS) or UE Specific Search Space (USS).

### Base Station

In one exemplary embodiment of the present disclosure, the base station may be a transmission reception point (TRP), a clusterhead, an access point, a remote radio head (RRH), an eNodeB (eNB), a gNodeB (gNB), a base station (BS), a base transceiver station (BTS), a base unit, or a gateway, for example. Further, in sidelink communication, a terminal may play a role of a base station. Furthermore, instead of the base station, a relay apparatus that relays communication between a higher node and a terminal may be used. Moreover, a road side device may be used.

### Uplink/Downlink/Sidelink

One exemplary embodiment of the present disclosure may be applied to, for example, any of an uplink, a downlink, and a sidelink. For example, one exemplary embodiment of the present disclosure may be applied to an uplink Physical Uplink Shared Channel (PUSCH), Physical Uplink Control Channel (PUCCH), or Physical Random Access Channel (PRACH), a downlink Physical Downlink Shared Channel (PDSCH), PDCCH, or Physical Broadcast Channel (PBCH), or a sidelink Physical Sidelink Shared Channel (PSSCH), Physical Sidelink Control Channel (PSCCH), or Physical Sidelink Broadcast Channel (PSBCH).

Note that the PDCCH, the PDSCH, the PUSCH, and the PUCCH are examples of a downlink control channel, a downlink data channel, an uplink data channel, and an uplink control channel, respectively. Further, the PSCCH and the PSSCH are examples of a sidelink control channel and a sidelink data channel, respectively. Further, the PBCH and PSBCH are examples of broadcast channels, and the PRACH is an example of a random access channel.

### Data Channel/Control Channel

One exemplary embodiment of the present disclosure may be applied to, for example, any of a data channel and a control channel. For example, a channel in one exemplary embodiment of the present disclosure may be replaced with any one of the PDSCH, the PUSCH, and the PSSCH being the data channels, or the PDCCH, the PUCCH, the PBCH, the PSCCH, and the PSBCH being the control channels.

### Reference Signal

In one exemplary embodiment of the present disclosure, a reference signal is a signal known to both of a base station and a terminal, and may also be referred to as a Reference Signal (RS) or a pilot signal. The reference signal may be any of a Demodulation Reference Signal (DMRS), a Channel State Information-Reference Signal (CSI-RS), a Tracking Reference Signal (TRS), a Phase Tracking Reference Signal (PTRS), a Cell-specific Reference Signal (CRS), or a Sounding Reference Signal (SRS).

### Time Intervals

In one exemplary embodiment of the present disclosure, a time resource unit is not limited to one or a combination of slots and symbols, and may be a time resource unit, such as a frame, superframe, subframe, slot, time slot, subslot, minislot, or a time resource unit, such as a symbol, orthogonal frequency division multiplexing (OFDM) symbol, single carrier-frequency division multiplexing access (SC-FDMA) symbol, or another time resource unit. The number of symbols included in one slot is not limited to the number of symbols exemplified in the above-described embodiments, and may be another number of symbols.

### Frequency Band

An exemplary embodiment of the present disclosure may be applied to any of a licensed band or an unlicensed band (unlicensed spectrum, shared spectrum). In a case of an unlicensed band, a channel access procedure (or Listen Before Talk (LBT), carrier sense, and/or Channel Clear Assessment (CCA)) may be performed prior to transmission of each signal.

### Communication

One exemplary embodiment of the present disclosure may be applied to any of communication between a base station and a terminal (Uu link communication), communication between a terminal and a terminal (Sidelink communication), and communication of a Vehicle to Everything (V2X). For example, the PDCCH in one exemplary embodiment of the present disclosure may be replaced with PSCCH, the PUSCH/PDSCH may be replaced with PSSCH, the PUCCH may be replaced with Physical Sidelink Feedback Channel (PSFCH), and the PBCH may be replaced with PSBCH.

Further, one exemplary embodiment of the present disclosure may be applied to any of a terrestrial network or a network (Non-Terrestrial Network (NTN)) other than a terrestrial network using a satellite or a High Altitude Pseudo Satellite (HAPS). Further, one exemplary embodiment of the present disclosure may be applied to a network having a large cell size, and a terrestrial network with a large delay compared with a symbol length or a slot length, such as an ultra-wideband transmission network.

### Antenna Port

In an exemplary embodiment of the present disclosure, an antenna port refers to a logical antenna (antenna group) formed of one or more physical antenna(s). For example, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal is allowed to transmit a reference signal. The antenna port may also be defined as the minimum unit for multiplication of a precoding vector weighting.

### 5G NR System Architecture and Protocol Stacks

The 3GPP has been working at the next release for the 5th generation cellular technology, simply called 5G, including the development of a new radio access technology (NR) operating in frequencies ranging up to 100 GHz. The first version of the 5G standard was completed at the end of 2017, which allows proceeding to 5G NR standard-compliant trials and commercial deployments of terminals (e.g., smartphones).

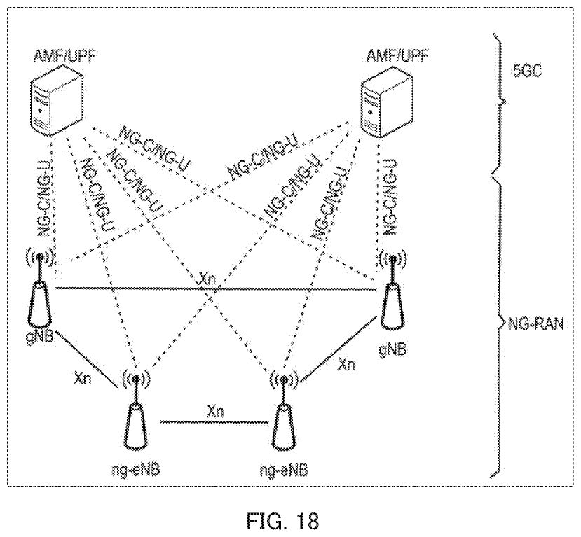

For example, the overall system architecture assumes an NG-RAN (Next Generation-Radio Access Network) that includes gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g., a particular core entity performing the AMF) by means of the NG-C interface and to the UPF (User Plane Function) (e.g., a particular core entity performing the UPF) by means of the NG-U interface. The NG-RAN architecture is illustrated in FIG. 18 (see e.g., 3GPP TS 38.300v15.6.0 , section 4).

The user plane protocol stack for NR (see, e.g., 3GPP TS 38.300, section 4.4.1) includes the Packet Data Convergence Protocol (PDCP, see clause 6.4 of TS 38.300) Radio Link Control (RLC, see clause 6.3 of TS 38.300) and Medium Access Control (MAC, see clause 6.2 of TS 38.300) sublayers, which are terminated in the gNB on the network side. Additionally, a new Access Stratum (AS) sublayer (SDAP, Service Data Adaptation Protocol) is introduced above the PDCP (see e.g., clause 6.5 of 3GPP TS 38.300). A control plane protocol stack is also defined for NR (see for instance TS 38.300, section 4.4.2). An overview of the Layer 2 functions is given in clause 6 of TS 38.300. The functions of the PDCP, RLC, and MAC sublayers are listed respectively in clauses 6.4, 6.3, and 6.2 of TS 38.300. The functions of the RRC layer are listed in clause 7 of TS 38.300.

For instance, the Medium Access Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. The physical layer also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For example, the physical channels include a Physical Random Access Channel (PRACH), Physical Uplink Shared Channel (PUSCH), and Physical Uplink Control Channel (PUCCH) as uplink physical channels, and a Physical Downlink Shared Channel (PDSCH), Physical Downlink Control Channel (PDCCH), and Physical Broadcast Channel (PBCH) as downlink physical channels.

Use cases/deployment scenarios for NR could include enhanced mobile broadband (eMBB), ultra-reliable low-latency communications (URLLC), and massive machine type communication (mMTC), which have diverse requirements in terms of data rates, latency, and coverage. For example, eMBB is expected to support peak data rates (20 Gbps for downlink and 10 Gbps for uplink) and user-experienced data rates on the order of three times what is offered by IMT-Advanced. Meanwhile, in case of URLLC, the tighter requirements are put on ultra-low latency (0.5 ms for UL and DL each for user plane latency) and high reliability (1-10-5 within 1 ms). Finally, the mMTC may preferably require high connection density (1,000,000 devices/km2 in an urban environment), large coverage in harsh environments, and extremely long-life battery for low cost devices (15 years).

Therefore, the OFDM numerology (e.g., subcarrier spacing, OFDM symbol duration, cyclic prefix (CP) duration, and number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacings of 15 kHz, 30 kHz, and 60 kHz, . . . are being considered at the moment. The symbol duration Tu and the subcarrier spacing Δf are directly related through the formula Δf=1/Tu. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211v15.6.0 ).

Functional Split between NG-RAN and 5GC in 5G NR

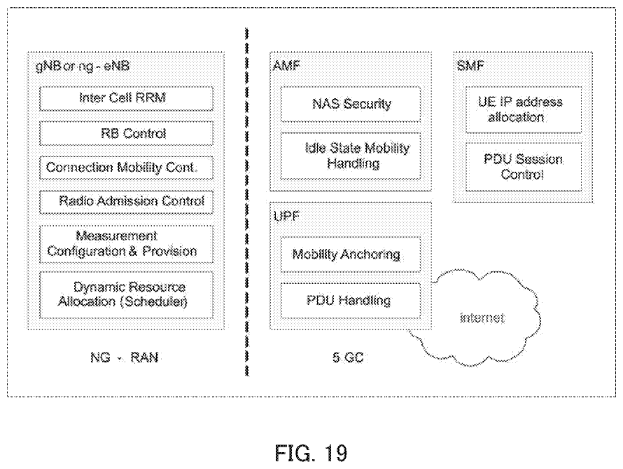

FIG. 19 illustrates functional split between NG-RAN and 5GC. A logical node of the NG-RAN is gNB or ng-eNB. The 5GC includes logical nodes AMF, UPF, and SMF.

For example, gNB and ng-eNB host the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of user plane data towards UPF(s);
Routing of control plane information towards AMF;
Connection setup and release;
Scheduling and transmission of paging messages;
Scheduling and transmission of system broadcast information (originated from the AMF or Operation, Admission, Maintenance (OAM));
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Function of Non-Access Stratum (NAS) signaling termination;
NAS signaling security;
Access Stratum, AS, Security control;
Inter-Core Network (CN) node signaling for mobility between 3GPP access networks;
Idle mode UE Reachability (including control and execution of paging retransmission);
Registration area management;
Support of intra-system and inter-system mobility;
Access Authentication;
Access Authorization including check of roaming rights;
Mobility management control (subscription and policies);
Support of Network Slicing;
Session Management Function (SMF) selection

Further, the User Plane Function (UPF) hosts the following main functions:
Anchor point for Intra-/Inter-RAT mobility (when applicable);
External Protocol Data Unit (PDU) session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g., packet filtering, gating, UL/DL rate enforcement;
Uplink Traffic verification (SDF to QoS flow mapping);
Downlink packet buffering and downlink data indication triggering.

Finally, the Session Management Function (SMF) hosts the following main functions:
Session Management;
UE IP address allocation and management;
Selection and control of UP function;
Configuration function for traffic steering at the User Plane Function (UPF) to route traffic to a proper destination;
Control part of policy enforcement and QoS; and
Downlink data indication.

### RRC Connection Setup and Reconfiguration Procedure

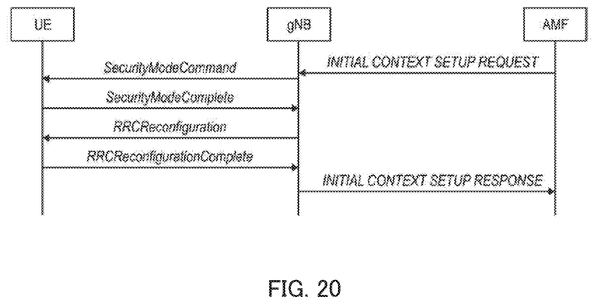

FIG. 20 illustrates some interactions between a UE, gNB, and AMF (a 5GC entity) in the context of a transition of the UE from RRC_IDLE to RRC_CONNECTED for the NAS part (see TS 38.300v15.6.0 ).

RRC is higher layer signaling (protocol) used for UE and gNB configuration. With this transition, the AMF prepares UE context data (which includes, for example, a PDU session context, security key, UE Radio Capability, UE Security Capabilities, and the like) and sends it to the gNB with an INITIAL CONTEXT SETUP REQUEST. Then, the gNB activates the AS security with the UE. This activation is performed by the gNB transmitting to the UE a SecurityModeCommand message and by the UE responding to the gNB using the Security ModeComplete message. Afterwards, the gNB performs the reconfiguration to setup the Signaling Radio Bearer 2 (SRB2) and Data Radio Bearer(s) (DRB(s)) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not set up. Finally, the gNB indicates the AMF that the setup procedure is completed with INITIAL CONTEXT SETUP RESPONSE.

Thus, the present disclosure provides a 5th Generation Core (5GC) entity (e.g., AMF, SMF, or the like) including control circuitry, which, in operation, establishes a Next Generation (NG) connection with a gNodeB, and a transmitter, which in operation, transmits an initial context setup message to the gNodeB via the NG connection such that a signaling radio bearer between the gNodeB and a User Equipment (UE) is set up. Specifically, the gNodeB transmits Radio Resource Control (RRC) signaling including a resource allocation configuration Information Element (IE) to the UE via the signaling radio bearer. Then, the UE performs an uplink transmission or a downlink reception based on the resource allocation configuration.

### Usage Scenarios of IMT for 2020 and Beyond

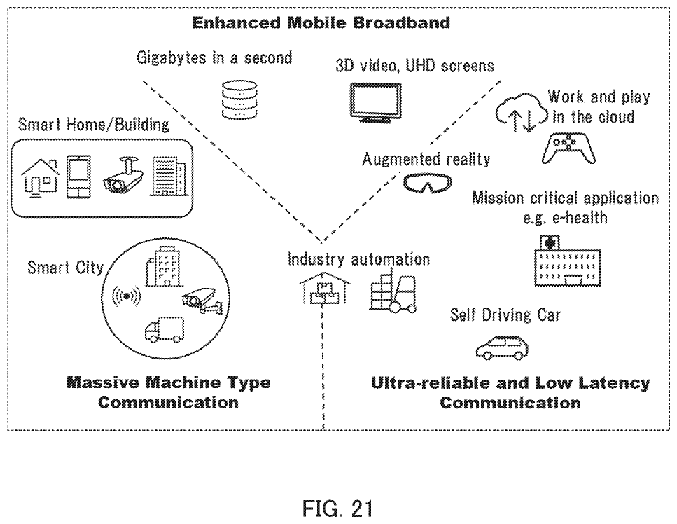

FIG. 21 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications (mMTC). FIG. 21 illustrates some examples of envisioned usage scenarios for IMT for 2020 and beyond (see, e.g., ITU-R M. 2083 FIG. 2).

The URLLC use case has stringent requirements for capabilities such as throughput, latency and availability. The URLLC use case has been envisioned as one of element techniques to enable future vertical applications such as wireless control of industrial manufacturing or production processes, remote medical surgery, distribution automation in a smart grid, transportation safety, etc. Ultra-reliability for the URLLC is to be supported by identifying the techniques to meet the requirements set by TR 38.913. For NR URLLC in Release 15, key requirements include a target user plane latency of 0.5 ms for uplink (UL) and 0.5 ms for downlink (DL). The general URLLC requirement for one transmission of a packet is a block error rate (BLER) of 1E-5 for a packet size of 32 bytes with a user plane latency of 1 ms.

From the physical layer perspective, reliability can be improved in a number of possible ways. The current scope for improving the reliability involves defining separate CQI tables for the URLLC, more compact DCI formats, repetition of PDCCH, etc. However, the scope may widen for achieving ultra-reliability as the NR becomes more stable and developed (for NR URLLC key requirements). Particular use cases of NR URLLC in Release 15 include augmented reality/virtual reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. The pre-emption means that a transmission for which resources have already been allocated is stopped, and the already allocated resources are used for another transmission that has been requested later but has lower latency/higher priority requirements. Accordingly, the already granted transmission is replaced with a later transmission. The pre-emption is applicable independent of the particular service type. For example, a transmission for a service-type A (URLLC) may be replaced with a transmission for a service type B (such as eMBB). Technology enhancements with respect to reliability improvement include dedicated CQI/MCS tables for the target BLER of 1E−5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability improvement in NR becomes wider. One key requirement to all the cases, and especially necessary for the URLLC and mMTC for example, is high reliability or ultra-reliability. Several mechanisms can be considered to improve the reliability from the radio perspective and network perspective. In general, there are a few key important areas that can help improve the reliability. These areas include compact control channel information, data/control channel repetition, and diversity with respect to the frequency, time, and/or spatial domain. These areas are applicable to reliability improvement in general, regardless of particular communication scenarios.

For NR URLLC, further use cases with tighter requirements have been considered such as factory automation, transport industry, and electrical power distribution. The tighter requirements are higher reliability (up to 10-6 level), higher availability, packet size of up to 256 bytes, time synchronization down to the order of a few μs where the value can be one or a few μs depending on frequency range and short latency in the order of 0.5 to 1 ms (e.g., target user plane latency of 0.5 ms) depending on the use cases.

Moreover, for NR URLLC, several technology enhancements from the physical layer perspective have been identified. These technology enhancements include Physical Downlink Control Channel (PDCCH) enhancements related to compact DCI, PDCCH repetition, and increased PDCCH monitoring. Further, Uplink Control Information (UCI) enhancements are related to enhanced Hybrid Automatic Repeat Request (HARQ) and CSI feedback enhancements. Also, PUSCH enhancements related to mini-slot level hopping and retransmission/repetition enhancements have been identified. The term “mini-slot” refers to a transmission time interval (TTI) including a smaller number of symbols than a slot (a slot includes 14 symbols).

### QoS Control

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearer (DRB) together with the PDU session, e.g., as illustrated above with reference to FIG. 20. Further, additional DRB(s) for QoS flow(s) of that PDU session can be subsequently configured (it is up to NG-RAN when to do so). The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

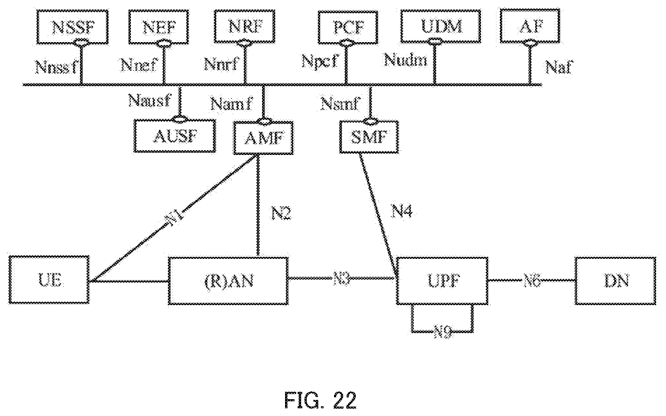

FIG. 22 illustrates a 5G NR non-roaming reference architecture (see TS 23.501 v16.1.0, section 4.23). An Application Function (AF) (e.g., an external application server hosting 5G services, exemplarily described in FIG. 21) interacts with the 3GPP Core Network in order to provide services, for example to support application influencing on traffic routing, accessing Network Exposure Function (NEF) or interacting with the policy framework for policy control (e.g., QoS control) (see Policy Control Function, PCF). Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 22 illustrates further functional units of the 5G architecture, namely a Network Slice Selection Function (NSSF), Network Repository Function (NRF), Unified Data Management (UDM), Authentication Server Function (AUSF), Access and Mobility Management Function (AMF), Session Management Function (SMF), and Data Network (DN, e.g., operator services, Internet access, or 3rd party services). All of or a part of the core network functions and the application services may be deployed and running on cloud computing environments.

In the present disclosure, thus, an application server (e.g., AF of the 5G architecture), is provided that includes a transmitter, which in operation, transmits a request containing a QoS requirement for at least one of the URLLC, eMMB, and mMTC services to at least one of functions (for example NEF, AMF, SMF, PCF, UPF, etc) of the 5GC to establish a PDU session including a radio bearer between a gNodeB and a UE in accordance with the QoS requirement, and control circuitry, which, in operation, performs the services using the established PDU session.

Any component termed with a suffix, such as “-er,” “-or,” or “-ar” in the above-described embodiments may be replaced with other terms such as “circuit (circuitry),” “device,” “unit,” or “module.”

Further, in the above-described embodiment, the values of parameters such as the number of RBs, a frequency bandwidth, and SCS are exemplary and may be other values.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. Further, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas. Some non-limiting examples of such a communication apparatus include a phone (e. g, cellular (cell) phone, smart phone), a tablet, a personal computer (PC) (e. g, laptop, desktop, netbook), a camera (e. g, digital still/video camera), a digital player (digital audio/video player), a wearable device (e. g, wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e. g, an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may include a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

A terminal according to one non-limiting exemplary embodiment of the present disclosure includes: control circuitry, which, in operation, determines, as a reception resource for a downlink signal, resource blocks distributedly mapped on a frequency axis among a plurality of resource blocks obtained by dividing a frequency band, wherein, a number of the resource blocks included in the reception resource is equal to or less than a defined value; and reception circuitry, which, in operation, receives the downlink signal by using the reception resource.

In one non-limiting exemplary embodiment of the present disclosure, in a case where a total number of the resource blocks included in a plurality of resource block groups (RBGs) configured for the terminal is larger than the defined value, the control circuitry determines a number of resource blocks equal to or less than the defined value in the plurality of RBGs as the reception resource.

In one non-limiting exemplary embodiment of the present disclosure, the control circuitry determines, as the reception resource, one or some of resource blocks included in each of a plurality of resource block groups (RBGs) configured for the terminal.

In one non-limiting exemplary embodiment of the present disclosure, a parameter related to the one or some of the resource blocks is indicated to the terminal.

In one non-limiting exemplary embodiment of the present disclosure, the control circuitry determines the reception resource based on at least one of a start resource block position of a first resource block group (RBG) and/or a size of the first RBG, the first RGB being any one of a lowest frequency RBG and a highest frequency RBG in a bandwidth part (BWP); and a total number of the resource blocks included in a plurality of the RBGs including the first RBG is equal to or less than the defined value.

In one non-limiting exemplary embodiment of the present disclosure, the control circuitry specifies a plurality of resource block groups (RBGs) in a bandwidth part (BWP) based on information on at least one of a number of and/or a size of RBGs; and a total number of the resource blocks included in the plurality of RBGs is smaller than a number of the resource blocks included in the BWP.

In one non-limiting exemplary embodiment of the present disclosure, the control circuitry determines the reception resource based on a plurality of resource indication values (RIVs) indicated to the terminal.

A base station according to one non-limiting exemplary embodiment of the present disclosure includes: control circuitry, which, in operation, determines, as a transmission resource for a downlink signal, resource blocks distributedly mapped on a frequency axis among a plurality of resource blocks obtained by dividing a frequency band, wherein, a number of the resource blocks included in the transmission resource is equal to or less than a defined value; and transmission circuitry, which, in operation, transmits the downlink signal by using the transmission resource.

A communication method according to one non-limiting exemplary embodiment of the present disclosure includes: determining, by a terminal, as a reception resource for a downlink signal, resource blocks distributedly mapped on a frequency axis among a plurality of resource blocks obtained by dividing a frequency band, wherein a number of the resource blocks included in the reception resource is equal to or less than a defined value; and receiving, by the terminal, the downlink signal by using the reception resource.

A communication method according to one non-limiting exemplary embodiment of the present disclosure includes: determining, by a base station, as a transmission resource for a downlink signal, resource blocks distributedly mapped on a frequency axis among a plurality of resource blocks obtained by dividing a frequency band, wherein, a number of the resource blocks included in the transmission resource is equal to or less than a defined value; and transmitting, by the base station, the downlink signal by using the transmission resource.

The disclosure of Japanese Patent Application No. 2023-107284, filed on Jun. 29, 2023, including the specification, drawings and abstract, is incorporated herein by reference in its entirety.

### Industrial Applicability

An exemplary embodiment of the present disclosure is useful for radio communication systems.

### Reference Signs List

100 Base station
101, 206 Controller
102 DCI generator
103 Higher-layer signal generator
104, 207 Encoder/modulator
105, 208 Signal mapper
106, 209 Transmitter
107, 201 Antenna
108, 202 Receiver
109, 203 Signal separator
110, 205 Demodulator/decoder
200 Terminal
204 DCI detector

1. A terminal, comprising:
control circuitry, which, in operation, determines, as a reception resource for a downlink signal, resource blocks distributedly mapped on a frequency axis among a plurality of resource blocks obtained by dividing a frequency band, wherein, a number of the resource blocks included in the reception resource is equal to or less than a defined value; and
reception circuitry, which, in operation, receives the downlink signal by using the reception resource.

2. The terminal according to claim 1, wherein, in a case where a total number of the resource blocks included in a plurality of resource block groups (RBGs) configured for the terminal is larger than the defined value, the control circuitry determines a number of resource blocks equal to or less than the defined value in the plurality of RBGs as the reception resource.

3. The terminal according to claim 1, wherein, the control circuitry determines, as the reception resource, one or some of resource blocks included in each of a plurality of resource block groups (RBGs) configured for the terminal.

4. The terminal according to claim 3, wherein, a parameter related to the one or some of the resource blocks is indicated to the terminal.

5. The terminal according to claim 1, wherein,
the control circuitry determines the reception resource based on at least one of a start resource block position of a first resource block group (RBG) and/or a size of the first RBG, the first RGB being any one of a lowest frequency RBG and a highest frequency RBG in a bandwidth part (BWP); and
a total number of the resource blocks included in a plurality of the RBGs including the first RBG is equal to or less than the defined value.

6. The terminal according to claim 1, wherein,
the control circuitry specifies a plurality of resource block groups (RBGs) in a bandwidth part (BWP) based on information on at least one of a number of and/or a size of RBGs; and
a total number of the resource blocks included in the plurality of RBGs is smaller than a number of the resource blocks included in the BWP.

7. The terminal according to claim 1, wherein, the control circuitry determines the reception resource based on a plurality of resource indication values (RIVs) indicated to the terminal.

8. A base station, comprising:
control circuitry, which, in operation, determines, as a transmission resource for a downlink signal, resource blocks distributedly mapped on a frequency axis among a plurality of resource blocks obtained by dividing a frequency band, wherein, a number of the resource blocks included in the transmission resource is equal to or less than a defined value; and
transmission circuitry, which, in operation, transmits the downlink signal by using the transmission resource.

9. A communication method, comprising:
determining, by a terminal, as a reception resource for a downlink signal, resource blocks distributedly mapped on a frequency axis among a plurality of resource blocks obtained by dividing a frequency band, wherein a number of the resource blocks included in the reception resource is equal to or less than a defined value; and
receiving, by the terminal, the downlink signal by using the reception resource.

10. A communication method, comprising:
determining, by a base station, as a transmission resource for a downlink signal, resource blocks distributedly mapped on a frequency axis among a plurality of resource blocks obtained by dividing a frequency band, wherein, a number of the resource blocks included in the transmission resource is equal to or less than a defined value; and
transmitting, by the base station, the downlink signal by using the transmission resource.
